(19) United States
(12) Patent Application Publication
(10) Pub. No.: US 2022/0333402 A1
(43) Pub. Date: Oct. 20, 2022

(54) BARRIER AND PANEL THEREOF

(71) Applicant: Dragox Pty Ltd, Bayswater WA (AU)

(72) Inventors: Graeme Greaves, Bayswater WA (AU); Thomas Greaves, Bayswater WA (AU)

(73) Assignee: Dragox Pty Ltd, Bayswater WA (AU)

(21) Appl. No.: 17/634,013

(22) PCT Filed: Aug. 7, 2020
(86) PCT No.: PCT/AU2020/050818

§ 371 Date: Feb. 9, 2022

(30) Foreign Application Priority Data
Aug. 9, 2019 (AU) 2019902852
Aug. 13, 2019 (AU) 2019902917
Oct. 29, 2019 (AU) 2019904064

(51) Int. Cl. E04H 17/16; F16M 13/02

(52) U.S. Cl. CPC E04H 17/17; F16M 13/02

(57) ABSTRACT

A barrier, such as for example in relation to safeguarding of machinery and in particular to a barrier, a barrier panel for a barrier, and a mounting assembly for mounting a barrier panel in position to provide a barrier. The invention is particularly applicable as panel and barrier for use in relation to belt conveyor guarding. The barrier comprises at least one panel comprising a body having a marginal portion bounded by a peripheral edge and an inner portion, a plurality of openings extending through the inner portion, and a stiffening formation extending from the inner portion to the marginal portion, the stiffening formation being integrated with and being defined by a portion of the body.

### TECHNICAL FIELD

This invention relates to a barrier and panel therefor, and a mounting assembly for mounting a barrier panel in position to provide a barrier.

The invention relates more particularly, although not exclusively, safety barriers, such as for example in relation to safeguarding of machinery and in particular to a barrier, a barrier panel for a barrier, and a mounting assembly for mounting a barrier panel in position to provide a barrier.

The invention is particularly applicable as panel and barrier for use in relation to belt conveyor guarding. Accordingly, it will be convenient to hereinafter disclose the invention in relation to that exemplary application. However, it is to be appreciated that the invention can of course have other applications apart from use in relation to belt conveyor guarding or a safety barrier more generally; for example, it may be used in relation to a machine guard, a visual barrier, fencing or a divider.

### BACKGROUND ART

The following discussion of the background art is intended to facilitate an understanding of the present invention only. The discussion is not an acknowledgement or admission that any of the material referred to is or was part of the common general knowledge as at the priority date of the application.

Conveyor guarding is designed as a safety measure to restrict access to danger zones in and about belt conveyors. The guarding may typically comprise a barrier comprising a barrier wall demarcating a danger zone or a barrier enclosure or cage about a danger zone.

Conveyor guarding typically comprises mesh or perforated panels formed from metal, typically sheet metal. The panels are of mesh or perforated construction so as to afford some visibility therethrough and also allow ventilation.

While metal mesh or perforated panels are generally considered to be effective in relation to conveyor guarding as well as safety barriers more generally, they can be relatively expensive to manufacture and relatively heavy to transport and install.

It would be advantageous for there to be a non-metal panel which could be used in relation to conveyor guarding and other applications where mesh or perforated panels are required as barriers. Materials that might be contemplated for such a non-metal panel might include engineering plastics and composite materials. Engineering plastics and composite materials may be desirable as they are not prone to rust or corrosion, and are typically chemical resistant. Further, a panel formed of such material would likely be less vulnerable to bending and warping. Additionally, a panel formed of non-metal would likely be easier to install and be non-magnetic (and thus would not interfere with metal detectors).

However, production of a non-metal panel can be challenging, as the panel would need sufficient stiffness to perform the requisite barrier function.

There is also a need for an effective way of mounting non-metal panels in position of a support structure to provide a barrier to restrict access to danger zones in and about belt conveyors.

It is against this background that the present invention has been developed.

### SUMMARY OF INVENTION

According to a first aspect of the present invention there is provided a panel comprising a body having a marginal portion bounded by a peripheral edge and an inner portion, a plurality of openings extending through the inner portion, and a stiffening formation extending from the inner portion to the marginal portion, the stiffening formation being integrated with and being defined by a portion of the body.

The stiffening formation may be bounded by a plurality of zones within the inner portion in which the openings are located.

The stiffening formation is preferably devoid of any of the openings. However, it may be that the stiffening formation could possibly incorporate some openings, although not to an extent which would adversely compromise the integrity of the stiffening formation. For example, any opening(s) in the stiffening formation may be smaller in size, sparser, or configured differently from the other openings in order not to compromise the integrity of the stiffening formation adversely.

The stiffening formation may comprise an inner section and a plurality of webs extending outwardly from the inner section to the marginal portion.

The inner section may provide a solid area within the inner portion; that is, an area devoid of openings. However, it may be that the inner section could possibly incorporate some openings, although not to an extent which would adversely compromise the integrity of the stiffening formation.

The inner section may be of any appropriate configuration. In an embodiment, the inner section may be rectangular and each web may extend from the rectangular inner section at or adjacent a respective corner thereof. Other configurations of the inner section are contemplated, including for example a circular inner section.

The plurality of webs may comprise four webs.

The four webs may be arranged in an X configuration. The X configuration may be centred on or extend from the inner section.

In practical terms, the stiffening formation may be formed by providing the openings within the inner portion in a particular pattern. The pattern may comprise the holes being arranged clusters which cooperate to provide the stiffening formation.

In the case of the stiffening formation comprising an inner section and a plurality of webs extending outwardly from the inner section, the pattern of openings may comprise four clusters, wherein one web is formed between each two adjacent clusters.

The openings in each cluster may be in an array having tapered sides, wherein the neighbouring tapered sides of adjacent arrays cooperate to define a respective one of the webs. In an embodiment, each cluster may comprise a generally trapezoidal array, with the smaller base of each trapezoid being adjacent the inner section of the stiffening formation. Other arrangements are contemplated; for example, in another embodiment, each cluster may comprise a generally triangular array, with the apex of each triangle being adjacent the inner section of the stiffening formation.

The arrays in the clusters may be of the same configuration or of different configurations, or a combination thereof. In an embodiment, arrays within clusters which are in opposed relation are of the same configuration.

The openings may comprise slots.

The slots may be oriented such that the longitudinal axes of the various slots in each cluster are either aligned with or parallel to one another.

The slots in each cluster may be arranged in an array comprising rows and columns, with respective longitudinal axes of the slots in each column being in alignment.

The slots may have opposed ends which are rounded.

The slots may be oriented such that the longitudinal axes of the slots are normal to an adjacent section of the peripheral edge of the body.

The marginal portion may comprise a respective zone adjacent each cluster of openings. At least some of the zones may comprise further openings. The further openings within each zone may be arranged in a row. The row may extend parallel to an adjacent section of the peripheral edge of the body.

In an embodiment in which there are four clusters, the marginal portion may comprise four zones, wherein the four zones are arranged as two pairs and the particular zones in each pair are disposed in opposed relationship, and wherein one pair of zones comprises further openings and the other pair of zones is devoid of further openings. Where each cluster comprises a generally trapezoidal array, the particular zone adjacent the larger base of the trapezoid may comprise the further openings. The further openings may be arranged in a row extending parallel to the larger base of the trapezoid.

The further openings may be of a similar configuration to the openings in the inner portion of the body.

The further openings may comprise slots and more particularly may comprise rounded slots.

While the peripheral edge may be of any appropriate configuration, it is typically generally rectangular. Other configurations are of course contemplated, including other polygonal configurations, circular and oval configurations and freeform configurations. In the case of the peripheral edge being generally rectangular, the panel may comprise a square panel or an elongate panel (in which two opposed sides are longer than the other two opposed sides).

The marginal portion of the body may include reinforcement means such as a side flange to enhance the rigidity of the panel. In the case of a rectangular panel, the side flange may be provided adjacent one or more of the sides of the body.

The panel may have provision for mounting on a support structure. Such provision may comprise a mounting portion integrated with the body and adapted to cooperate with a counterpart portion on the support structure. The mounting portion integrated with the body may be formed by configuring the body to provide a protrusion at the peripheral edge, wherein the protrusion provides the mounting portion.

In the case of a rectangular panel, there may be two protrusions on opposed sides of the body, each protrusion providing an upper mounting portion and a lower mounting portion on the respective side of the panel.

With the panel according to the first aspect of the invention, the stiffening formation being integrated with the body provides the panel with lateral stiffness. More particularly, the stiffening formation provides the panel with sufficient lateral stiffness to perform the function of a barrier panel. Such stiffness may be enhanced by any presence of the reinforcement means such as a side flange in the marginal portion of the body.

The stiffening formation is configured to transfer stresses arising in the panel to the marginal portion of the panel body, where the panel would typically be mounted on a support arrangement such as a support structure.

The pattern of the openings and the configuration of the openings (e.g. the slots) are preferably selected such that the sections of the inner portion bounding the slots provide uninterrupted pathways along which stresses can be transferred outwardly towards the marginal portion. Further, the pattern of the openings and the configuration of the openings (e.g. the slots) are preferably selected to minimize localised stresses within the body.

The mounting portion of the panel may be formed by configuring the panel to provide a protrusion at a peripheral edge, wherein the protrusion provides the mounting portion.

Preferably, each side edge section of the panel comprises a protrusion.

Preferably, each protrusion comprises indentations defined by cut-outs indenting partially from the outer edge of the peripheral edge towards the centre of the panel.

The panel may comprise two protrusions on opposed side edge sections thereof, each protrusion providing an upper mounting portion and a lower mounting portion on the respective side of the panel.

According to a second aspect of the invention there is provided a panel comprising a body having a peripheral edge and a protrusion at a peripheral edge, wherein the protrusion provides a mounting portion.

Preferably, each side edge section of the panel comprises a protrusion.

Preferably, each protrusion comprises indentations defined by cut-outs indenting partially from the outer edge of the peripheral edge towards the centre of the panel.

The panel according to the second aspect of the invention may comprise two protrusions on opposed side edge sections of the body, each protrusion providing an upper mounting portion and a lower mounting portion on the respective side of the panel.

According to a third aspect of the invention there is provided a mounting bracket comprising a backing plate and an outer portion spaced apart from the blacking plate defining a recess adjacent the backing plate for receiving a mounting portion of a panel.

The outer portion is attached to the backing plate via a flange extending from the backing plate defining the recess.

The recess is adapted to receive one or more portions of side edge sections of the panel.

The recess comprises end openings and side openings for receiving or more portions of side edge sections of the panel.

In one arrangement, the mounting bracket comprises a plurality end openings and side openings for receiving portions of panels that are located side by side.

Preferably, the mounting bracket comprises a partition for dividing the recess in two sub-recess.

Preferably, the partition comprises a protrusion acting as a locator.

In another arrangement, the mounting bracket comprises one end openings and one side openings for receiving portions of one panel.

Preferably, the mounting bracket is a right-hand mounting bracket.

Preferably, the mounting bracket is a left-hand mounting bracket.

The mounting bracket comprises means for securing the panel to the mounting bracket.

The means for securing the panel to the mounting bracket comprises welded nuts.

According to a fourth aspect of the invention there is provided a barrier comprising a panel having a mounting portion, and a mounting assembly for mounting the panel in position, wherein the mounting assembly comprises a counterpart portion adapted to cooperate with the mounting portion of the panel, the counterpart portion comprising a face against which the mounting portion of the panel can be located, whereby forces imposed upon the panel can be transferred through the respective mounting portion to the face of the counterpart portion.

With this arrangement the barrier comprises a barrier assembly comprising the panel and the mounting assembly.

The mounting assembly may comprise two or more of counterpart portions, being an upper counterpart portion, and a lower counterpart portion.

Preferably, the mounting assembly may further comprise at least one middle counterpart portions.

The lower counterpart portion may be configured such that the panel can rest thereon.

The upper counterpart portion may be configured such that the panel is received and retained therein.

The upper counterpart portion may comprise means operable to releasably lock the panel in position.

In a particular arrangement, the lower counterpart portion may comprise means operable to releasably lock the panel in position.

The upper and lower counterpart portions may be configured as mounting brackets; for example, top, middle and bottom mounting brackets.

Preferably, each mounting bracket comprises a mounting bracket according to the third embodiment of the invention.

The mounting brackets may be incorporated in a support structure. For example, the mounting brackets may be attached to frame members of a support structure.

The mounting portion of the panel may be formed by configuring the panel to provide a protrusion at a peripheral edge, wherein the protrusion provides the mounting portion.

The protrusion may provide an upper mounting portion and a lower mounting portion.

The panel may comprise two protrusions on opposed side edge sections thereof, each protrusion providing an upper mounting portion and a lower mounting portion on the respective side of the panel.

The barrier assembly may comprise a plurality of panels and the mounting assembly may be configured to receive two panels disposed one adjacent another within the barrier assembly.

The barrier assembly may comprise a plurality of the mounting assemblies adapted to receive a plurality of the panels disposed one adjacent another within the barrier assembly.

According to a fifth aspect of the invention there is provided a mounting assembly for a panel according to the third or fourth aspect of the invention, the mounting assembly comprising a counterpart portion adapted to cooperate with the mounting portion of the panel, the counterpart portion comprising a face against which the mounting portion of the panel can be located, whereby forces imposed upon the panel can be transferred through the respective mounting portion to the face of the counterpart portion.

According to a sixth aspect of the invention there is provided a mounting assembly for a panel having a mounting portion, the mounting assembly comprising a counterpart portion adapted to cooperate with the mounting portion, the counterpart portion comprising a face against which the mounting portion can be located, whereby forces imposed upon the panel can be transferred through the respective mounting portion to the face of the counterpart portion.

The mounting assembly according to the fifth or sixth aspect of the invention may comprise two counterpart portions, being an upper counterpart portion and a lower counterpart portion.

The lower counterpart portion may be configured such that the panel can rest thereon.

The upper counterpart portion may be configured such that the panel is received and retained therein. The upper counterpart portion may comprise means operable to releasably lock the panel in position.

In a particular arrangement, the lower counterpart portion may be configured such that the panel is received and retained therein. The lower counterpart portion may comprise means operable to releasably lock the panel in position.

The upper and lower counterpart portions may be configured as mounting brackets; for example, top, middle and bottom mounting brackets.

Preferably, the mounting brackets comprise the mounting brackets according to the third aspect of the invention.

The barrier assembly may further comprise a support on which the mounting assembly is mounted.

The support may present an exposed surface and the counterpart portion of the mounting assembly may be recessed with respect to the exposed surface, whereby said face of the counterpart portion aligns with the exposed surface of the support. With such an arrangement, the exposed surface of the support and said face of the counterpart portion cooperate to define an extended surface against which the mounting portion of the panel can locate, whereby forces imposed upon the panel can be transferred through the respective mounting portion to the extended surface; that is, such forces can be transferred to said face of the counterpart portion and to the exposed surface of the support.

The barrier assembly may further comprise a plurality of supports providing a support structure on which the mounting assemblies are provided. The mounting assemblies may be incorporated in the support structure. For example, the mounting assemblies may be attached to support members of the support structure.

The support structure may comprise a plurality of support members such as posts installed at intervals, whereby each panel can be mounted between and supported by adjacent posts.

The mounting assemblies may each comprises a top mounting bracket and a bottom mounting bracket mounted on each post. The top and bottom mounting brackets may each be configured to receive two panels which are disposed one adjacent another within the barrier assembly.

Each support may be configured to receive the respective mounting assembly and present a surface face which is coplanar with the face of said counterpart portion of the mounting assembly, whereby forces imposed upon the panel can be transferred through the respective mounting portion to the face of said counterpart portion and also the face of the support.

The support may incorporate a recess or recesses in which the respective mounting assembly is received. In one arrangement, the support has two recesses, one for receiving a top mounting bracket and the other for receiving a bottom mounting bracket.

According to a seventh aspect of the invention there is provided a support for a mounting assembly according to the fifth or sixth aspect of the invention, the support presenting an exposed surface and being configured to receive the mounting assembly with the counterpart portion of the mounting assembly recessed with respect to the exposed surface, whereby said face of the counterpart portion aligns with the exposed surface of the support.

The support may comprise a support post.

Where the mounting assembly comprises a top mounting bracket and a bottom mounting bracket, the support post may have two recesses each for receiving a respective one of the mounting brackets.

According to an eighth aspect of the invention there is provided in combination a mounting assembly according to the fifth or sixth aspect of the invention and a support according to the seventh aspect of the invention.

In the combination according to the eighth aspect of the invention, the mounting assembly and the support may be provided as separate components or as an integrated unit.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a perspective view of a first embodiment of a panel according to the invention;

FIG. 2 is a front view of the panel;

FIG. 3 is a side view of the panel;

FIG. 4 is a front perspective view of a barrier assembly comprising a plurality of panels according to the first embodiment;

FIG. 5 is a rear perspective view of a barrier assembly;

FIG. 6 is a front view of the barrier assembly;

FIG. 7 is a rear view of the barrier assembly;

FIG. 8 is a plan view of the barrier assembly;

FIG. 9 is a front perspective view of a portion of the barrier assembly;

FIG. 10 is a detailed view of part of FIG. 9;

FIG. 11 is a detailed view of a further part of FIG. 9;

FIG. 12 is a front view of a portion of the barrier assembly, illustrating the attachment of the panel to a support structure;

FIG. 13 is a side schematic view associated with FIG. 12, illustrating steps involved in attaching the panel to the support structure;

FIG. 14 is a perspective view of a post and associated upper and lower attachments brackets;

FIG. 15 is a front view of the arrangement shown in FIG. 14;

FIG. 16 is a side view of the arrangement shown in FIG. 16;

FIG. 17 is a perspective view of the upper attachment bracket;

FIG. 18 is a front view of the upper attachment bracket;

FIG. 19 is a side view of the upper attachment bracket;

FIG. 20 is a perspective view of the lower attachment bracket;

FIG. 21 is a front view of the lower attachment bracket;

FIG. 22 is a side view of the lower attachment bracket;

FIG. 23 is a perspective view of a second embodiment of a panel according to the invention;

FIG. 24 is a front view of the panel of FIG. 23;

FIG. 25 is a side view of the panel of FIG. 23;

FIG. 26 is a perspective view of a third embodiment of a panel according to the invention;

FIG. 27 is a front view of the panel of FIG. 26;

FIG. 28 is a side view of the panel of FIG. 26;

FIG. 29 is a schematic view of an enclosed guard featuring panels according to the invention;

FIG. 30 is a front perspective view of a fourth embodiment of a barrier according to the invention;

FIG. 31 is a rear perspective view of the barrier of FIG. 30;

FIG. 32 is a front view of the barrier;

FIG. 33 is a rear view of the barrier;

FIG. 34 is a plan view of the barrier;

FIG. 35 is a front perspective view of a portion of the barrier;

FIG. 36 is a detailed view of part of FIG. 35;

FIG. 37 is a detailed view of a further part of FIG. 35;

FIG. 38 is a front view of a portion of the barrier, illustrating the attachment of a panel to a support structure;

FIG. 39 is a side schematic view associated with FIG. 38, illustrating steps involved in attaching the panel to the support structure;

FIG. 40 is a perspective view of the panel;

FIG. 41 is a front view of the panel;

FIG. 42 is a side view of the panel;

FIG. 43 is a perspective view of a post and associated upper and lower attachments brackets;

FIG. 44 is a front view of the arrangement shown in FIG. 43;

FIG. 45 is a side view of the arrangement shown in FIG. 43;

FIG. 46 is a perspective view of a top attachment bracket;

FIG. 47 is a front view of the top attachment bracket;

FIG. 48 is a side view of the top attachment bracket;

FIG. 49 is a perspective view of a bottom attachment bracket;

FIG. 50 is a front view of the bottom attachment bracket;

FIG. 51 is a side view of the bottom attachment bracket; and

FIG. 52 is a schematic view of a fifth embodiment of a barrier according to the invention, the embodiment being configured as an enclosed guard;

FIG. 53 is a front perspective view of a sixth embodiment of a barrier according to the invention;

FIG. 54 is a rear perspective view of the barrier of FIG. 53;

FIG. 55 is a front view of the barrier;

FIG. 56 is a rear view of the barrier;

FIG. 57 is a plan view of the barrier;

FIG. 58 is a front perspective view of a portion of the barrier;

FIG. 59 is a detailed view of part of FIG. 58;

FIG. 60 is a detailed view of a further part of FIG. 58;

FIG. 61 is a front view of a portion of the barrier, illustrating the attachment of a panel to a support structure;

FIG. 62 is a side schematic view associated with FIG. 61, illustrating steps involved in attaching the panel to the support structure;

FIG. 63 is a perspective view of the panel;

FIG. 64 is a front view of the panel;

FIG. 65 is a side view of the panel;

FIG. 66 is a perspective view of a post and associated upper and lower attachments brackets;

FIG. 67 is a front view of the arrangement shown in FIG. 66;

FIG. 68 is a side view of the arrangement shown in FIG. 66;

FIG. 69 is a perspective view of a top mounting bracket;

FIG. 70 is a front view of the top mounting bracket;

FIG. 71 is a side view of the top mounting bracket;

FIG. 72 is a perspective view of a bottom mounting bracket;

FIG. 73 is a front view of the bottom mounting bracket;

FIG. 74 is a side view of the bottom mounting bracket;

FIG. 75 is a front view of a post and associated upper and lower mounting brackets in a seventh embodiment of a barrier according to the invention;

FIG. 76 is a side view of the arrangement shown in FIG. 75;

FIG. 77 is a front view of the post shown in FIGS. 75 and 76;

FIG. 78 is a side view of the post shown in FIGS. 75 and 76

FIG. 79 is a schematic view of an eighth embodiment of a barrier according to the invention, the embodiment being configured as an enclosed guard;

FIGS. 80 to 82 are front perspective view of a particular arrangement of top, centre and bottom mounting brackets;

FIGS. 83 to 85 are front perspective view of a particular arrangement of top, centre and bottom left-hand mounting brackets;

FIGS. 86 to 88 are front perspective view of a particular arrangement of top, centre and bottom right-hand mounting brackets;

FIGS. 89 and 90 are top and front perspective view of a particular arrangement of a particular arrangement of a barrier comprising the top, centre and bottom mounting brackets shown in FIGS. 80 to 82;

FIG. 91 is top perspective view of a post of a support structure of the barrier shown in FIGS. 89 and 90 including top, centre and bottom mounting brackets shown in FIGS. 80 to 82; and

FIG. 92 is front perspective view of a particular arrangement of top mounting brackets comprising welded nuts; and

FIGS. 92 to 94 are front perspective views of a particular arrangement of top, left-hand and right-hand mounting brackets.

In the drawings like structures are referred to by like numerals throughout the several views. The drawings shown are not necessarily to scale, with emphasis instead generally being placed upon illustrating the principles of the present invention

The figures depict several embodiments of the invention. The embodiments each illustrates a particular configuration; however, it is to be appreciated that the invention can take the form of many configurations, as would be obvious to a person skilled in the art, whilst still embodying the present invention. These configurations are to be considered within the scope of this invention.

### DESCRIPTION OF EMBODIMENTS

In the following detailed description, the present invention is described in connection with several preferred embodiments. However, to the extent that the following description is specific to a particular embodiment or a particular use of the present techniques, it is intended to be illustrative only and merely provides a concise description of the exemplary embodiment. Accordingly, the present invention is not limited to the specific embodiments described below, but rather the invention includes all alternatives, modifications, and equivalents falling within the true scope of the appended claims.

Referring to FIGS. 1 to 3, there is shown a first embodiment of a panel 110 according to the invention. The panel 110 is intended for use in in relation to conveyor guarding and other applications where a mesh or perforated panel may be required as safety barrier. However, other applications of the panel 110 are contemplated, including for example in relation to a machine guard, visual barrier, a fencing panel or a divider.

The panel 110 is of unitary construction and is formed of a rigid non-metal material. In this embodiment, the panel 110 may be formed of an engineering plastics material, such as a thermoplastic polymer. A suitable thermoplastic polymer may comprise HPDE, UPE, UHMWPE, PP, PVC and other various plastics, both normal and UV stable Other rigid non-metal materials are also contemplated, including composite material

The panel 110 comprises a body 111 having a marginal portion 113 bounded by a peripheral edge 115, and an inner portion 117. In the arrangement shown, the body 111 is configured as a generally rectangular sheet 119 having first and second opposed faces 121, 122. Because of the rectangular configuration of the body 111, the peripheral edge 115 is also generally rectangular, comprising a top edge section 123, a bottom edge section 125 and two opposed side edge sections 127. A recess 129 is provided at each corner of the rectangular sheet 119. Each of the side edge sections 127 includes a protrusion 131 providing an upper mounting portion 133 and a lower mounting portion 135 on the respective side of the panel 110, the purpose of which will be explained later. With this arrangement, the upper lower mounting portions 133, 135 are integrated with the body 111.

A plurality of openings 140 extend though the inner portion 117 between the opposed faces 121, 122. The openings 140 are arranged in a particular pattern which in this embodiment comprises clusters. More particularly, the openings 140 are arranged in four clusters 141, identified in the drawings individually by reference numerals 141a to 141d respectively.

The clusters 141 cooperate to define a stiffening formation 150 within the body 111. More particularly, the stiffening formation 150 is integrated with and defined by a portion of the body 111. The stiffening formation 150 extends from the inner portion 117 to the marginal portion 113 of the body 111.

Because the stiffening formation 150 is integrated with the body 111, it provides the panel 110 with sufficient lateral stiffness to perform the function of a barrier panel. More particularly, the stiffening formation 150 is designed to increase the strength of the barrier panel 110 and reduce deflection of the barrier panel when impacted. Further, the stiffening formation 150 and the marginal portion 115 with which it is integrated, together increase the amount of material within the body 111 available at stress points when an impact to the panel 110 occurs. The stiffening formation 150 is configured to transfer stresses arising in the panel 110 to the marginal portion 113 of the panel body 111, where the panel would typically be mounted on a support arrangement (as will be described later).

In this embodiment, the stiffening formation 150 comprises an inner section 151 and a plurality of webs 153 extending outwardly from the inner section 151 to the marginal portion 113 of the panel body 111. In the arrangement shown in which the pattern of the openings 140 comprises four clusters 141, there are four webs 153, with one web is formed between each two adjacent clusters.

The inner section 151 provides a solid area within the inner portion 117 of the body 111; that is, an area devoid of openings. In this way, the inner section enhances the strength of the barrier panel 110 and assists in reducing deflection of the panel when impacted.

The four webs 153 are arranged in an X configuration which is centred on and extends from the inner section 151. In the arrangement shown, the inner section 151 is rectangular and the webs 153 extends from the four corners of the rectangular inner section. It should be understood that the inner section 151 need not be rectangular and other configurations are contemplated, including for example a circular inner section.

In practical terms, the stiffening formation 150 is formed in this embodiment by providing the openings 140 within the inner portion 117 in the specified pattern comprising the four clusters 141. More particularly, the openings 140 in each cluster 141 are arranged in an array 161 having tapered sides 163, wherein the neighbouring tapered sides 163 of adjacent clusters 141 cooperate to define a respective one of the webs 153. In the arrangement shown, the array 161 of each cluster 141 is configured generally as a trapezoidal array having the tapered sides 163, as well as a smaller base 165 and a larger base 167. Each trapezoidal array 161 is oriented such that the smaller base 165 is adjacent the inner section 151 of the stiffening formation 150. Other arrangements are contemplated; for example, in another embodiment, each cluster 141 may comprise a generally triangular array, with the apex of each triangle being adjacent the inner section 151 of the stiffening formation 150.

In the arrangement shown, the arrays 161 within the clusters 141 are in two different configurations. The arrays of opposed clusters 141a, 141b are of the same configuration, and the arrays of opposed clusters 141c, 141d are of the same configuration. However, the configurations of opposed clusters 141a, 141b and opposed clusters 141c, 141d are different from each other. The difference arises in this case because of the rectangle configuration of the panel 111, with top and bottom edge sections 123, 125 being longer than the two opposed side edge sections 127.

The openings 140 are configured as slots. 170, each having longitudinal sides and rounded ends. The slots 170 are oriented in each cluster 141 such that their longitudinal axes are either aligned with or parallel to one another.

The slots 170 in each cluster 141 are arranged such that the respective array 161 comprises rows and columns, with respective longitudinal axes of the slots 170 in each column being in alignment.

Further, the slots 170 are oriented such that their longitudinal axes are normal to an adjacent section of the peripheral edge 115 of the body 111. By way of explanation, the slots 170 in cluster 141a are oriented such that their longitudinal axes are normal to top edge section 123 of the peripheral edge 115 of the body 111. Similarly, the slots 170 in clusters 141b, 141c and 141d are oriented such that their longitudinal axes are normal to bottom edge section 125 and the two side edge sections 127 respectively.

The marginal portion 115 comprise a respective zone 181 adjacent each cluster 141 of openings 140. The zones 181 enhance the lateral stiffness of the panel 110. In this embodiment, the zone 181a adjacent cluster 141a and the zone 181b adjacent cluster 141b each comprises further openings 183. The further openings 183 within each zone 181a, 181b are arranged in a row 185. Each row 185 extends parallel to an adjacent section of the peripheral edge 115. The further openings 183 are each configured as a rounded slot similar the openings 150 in the inner portion 117 of the body 111. Additionally, the rounded slots 183 are oriented so as to be parallel to the slots 150 in the adjacent cluster.

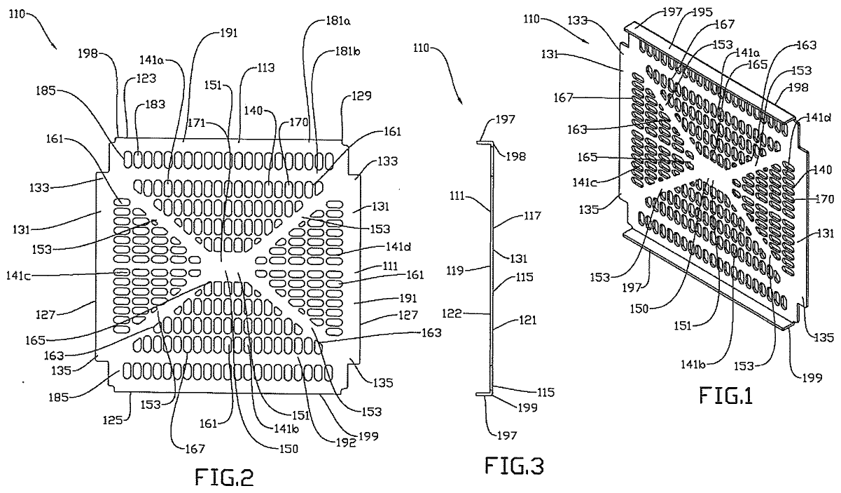

The presence of the further openings 183 offers enhanced visibility, ventilation and weight-reduction without compromising the integrity of zones 181a, 181b in enhancing the stiffness of the panel 110. This is because each zone 181a, 181b comprises two bands 191, 192 (see FIG. 2) on opposed sides of the respective row 185 (see FIG. 2), with the bands extending continuously between the two opposed side edges 127 of the body 111 of the panel 110.

The body 111 include reinforcement means 195 to enhance the rigidity of the panel. In the arrangement shown, the reinforcement means 195 comprises flanges 197 extending laterally from the body 111 at the top and bottom sides 198, 199 (which correspond to the top and bottom edge sections 123, 125). In the arrangement shown, the flanges 197 extend outwardly in a direction normal to the second face 122 of the panel 110.

As mentioned above, the stiffening formation 150 (being integrated with the body 111) provides the panel 110 with sufficient lateral stiffness to perform the function of a barrier panel. Such stiffness may be enhanced by any presence of the reinforcement means 195 such as the side flanges 197.

It is a feature of the above embodiment which has been described and illustrated that the stiffening formation 150 provides the panel 110 with sufficient lateral stiffness to perform the function of a barrier panel; specifically the stiffening formation 150 functions to increase the strength and reduce deflection of the panel when impacted. Further, the stiffening formation 150 and the marginal portion 115 with which it is integrated, together increase the amount of material within the body 111 available at stress points when an impact to the panel 110 occurs. The stiffening formation 150 is configured to transfer stresses arising in the panel 110 to the marginal portion 113 of the panel body 111, where the panel would typically be mounted on a support arrangement.

Further, it is a feature of the above embodiment that the openings 140 are configured as slots 170 grouped in clusters 141. The pattern of the slots 170 is selected such that material within the body 111 bounding the slots provides uninterrupted pathways along which stresses can be transferred outwardly towards the marginal portion. Further, the pattern of the slots 170 and the configuration of individual slots 170 are selected to minimize localised stresses within the body 111.

The pattern of the slots 170 is such that there are specific zones within the body 111 which are perforated; specifically, the zones at which the clusters 141 are located. Consequently, there are other zones within the body 111 which are not perforated (i.e. zones which are devoid of slots). These non-perforated zones include the inner section 151, the webs 153, and at part of the marginal portion 115. In this way, the panel 110 can be designed to ensure that more material is available within the body 111 at areas more likely to be vulnerable to impact.

The use of openings 140 configured as slots 170 and the strategic placement of the slots may result in a panel likely to be considerably more robust than a counterpart mesh panel having perforations arranged evenly throughout the entire body of the panel (as is typically the case with known prior art barrier panels).

Still further, it is a feature of the above embodiment that the openings 140 are configured as rounded slots 170. The rounded configuration of the slots 170 serves to inhibit stress raisers and so minimize localised stresses within the body 111.

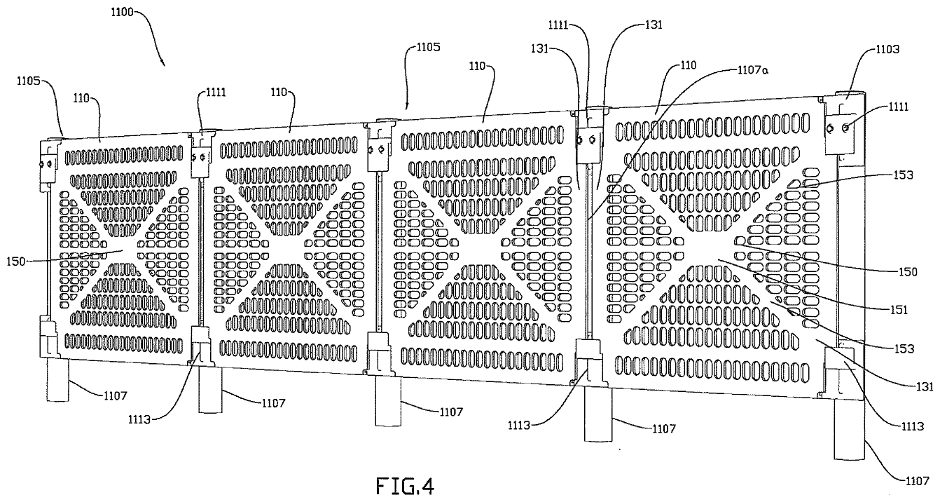

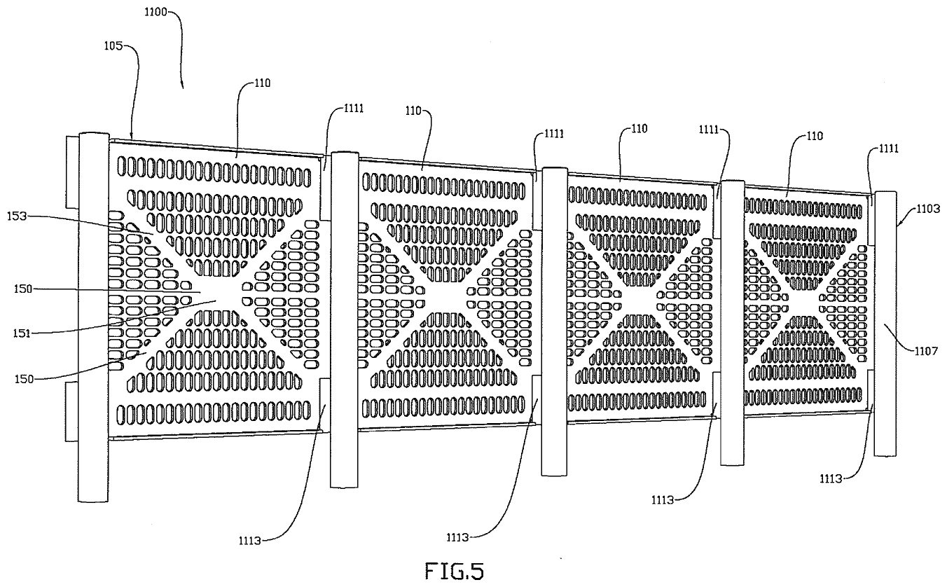

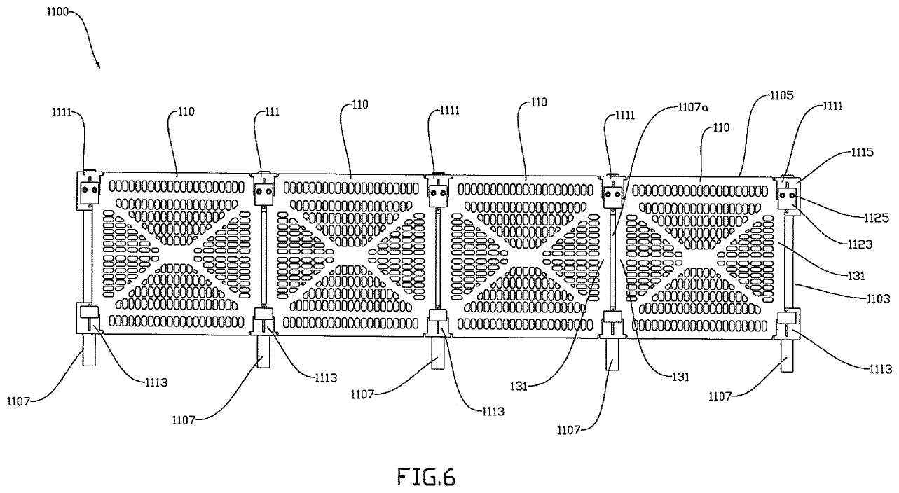

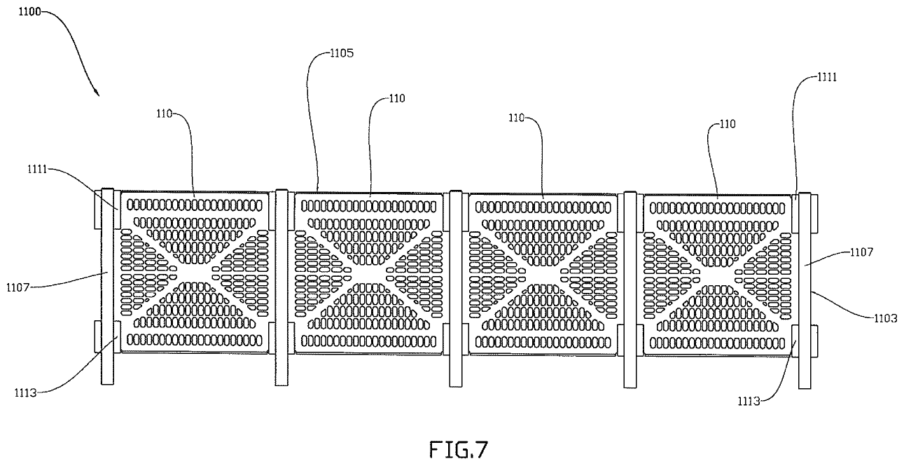

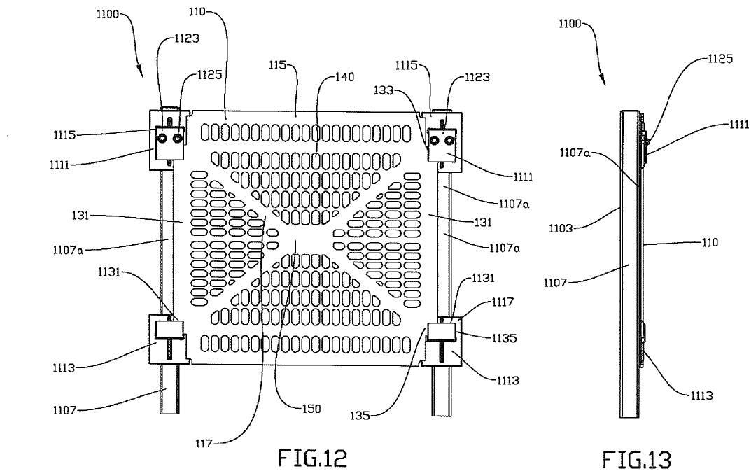

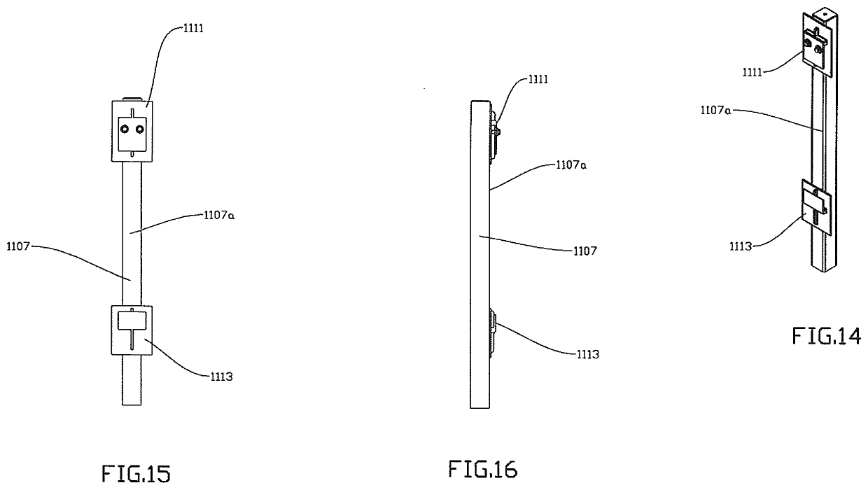

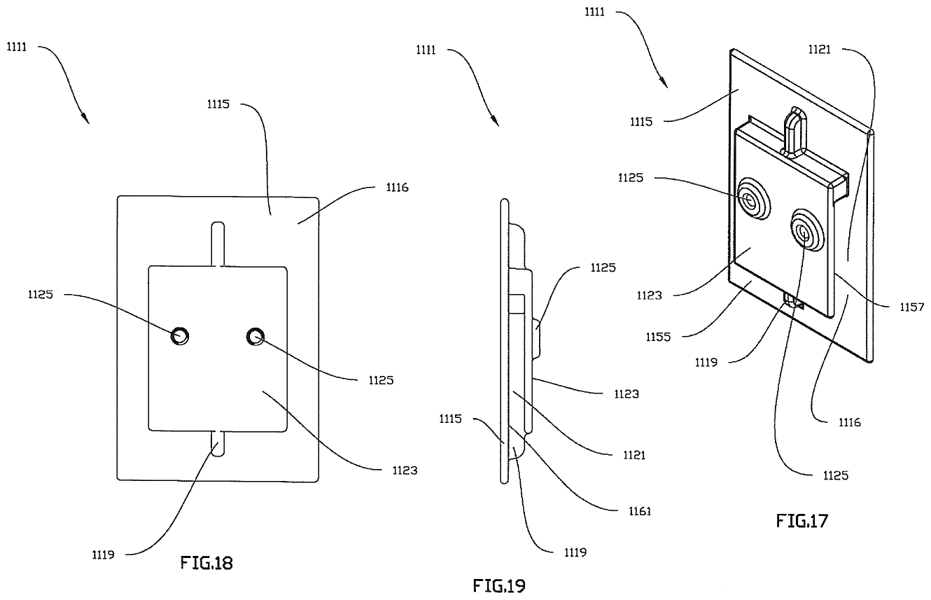

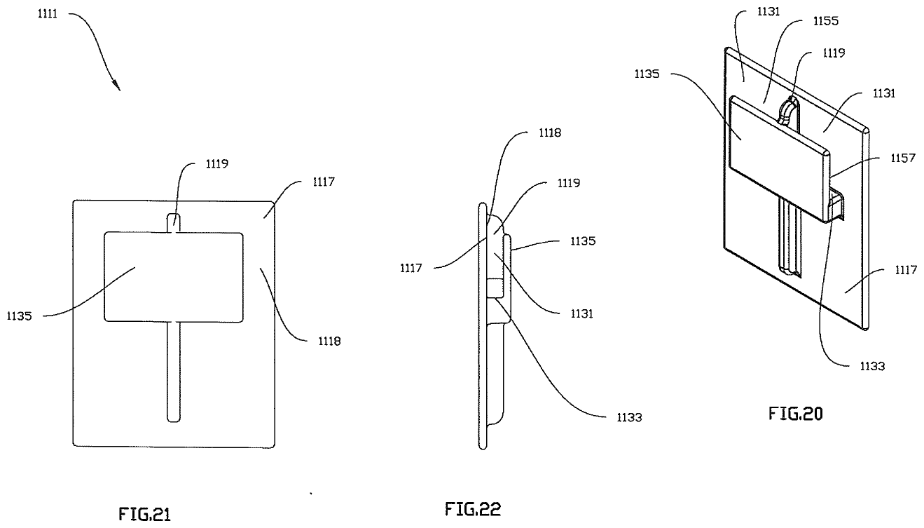

Referring now to FIGS. 4 to 21, there is shown a barrier assembly 1100 comprising a plurality the panels 110 mounted on a support arrangement in the form of a support structure 1103 to provide a safety barrier 1105.

In the arrangement shown, the support structure 1103 comprises a plurality of support members such as posts 1107 installed at intervals, whereby one panel 110 can be mounted between and supported by adjacent posts 1107.

The support structure 1103 further comprises a mounting assembly for mounting each panel 110 in position within the barrier assembly 1100. The mounting assembly comprises a top mounting bracket 1111 and a bottom mounting bracket 1113 mounted on each post 1107. The top and bottom mounting brackets 1111, 1113 are each configured to receive two panels 110 which are disposed one adjacent another within the barrier assembly 1100 (apart from perhaps the top and bottom mounting brackets for end posts to which only one panel would be attached). Each mounting bracket 1111,1113 comprises recesses 1121,1131 having end openings 1155 and side openings 1157.

The top mounting bracket 1111 comprises a top plate 1115 which presents a face 1116 against which the upper mounting portion 133 on the respective side of the panel 110 can locate. Similarly, bottom mounting bracket 1113 comprises a bottom plate 1117 which presents a face 1118 against which the lower mounting portion 135 on the respective side of the panel 110 can locate.

The top mounting bracket 1111 is configured to provide a downwardly opening recess 1121 adjacent the top plate 1115 into which the upper mounting portion 133 on the respective side of the panel 110 can be received and retained. The recess 1121 is defined between the top plate 1115 and an outer portion 1123 which incorporates two locking devices 1125, each for releasably locking the upper mounting portion 133 of the respective panel in position within the recess 1121.

The bottom mounting bracket 1113 is configured to provide an upwardly opening recess 1131 adjacent the bottom plate 1117 into which the bottom mounting portion 135 on the respective side of the panel 110 can be received and retained. The recess 1131 has a base 1133 on which the bottom mounting portion 135 can rest when received and retained therein. The recess 1131 is defined between the bottom plate 1117 and an outer portion 1135.

The locking devices 1125 may be of any appropriate form, and they need not necessarily be associated with the upper mounting bracket 1111. The locking devices 1125 may, for example, be associated with the lower mounting brackets 1111, or alternatively located separately of the mounting brackets 1111, 1113.

A protrusion 1119 is provided on each mounting bracket 1111, 1113. The protrusion 1119 functions as a locator (as will be explained later), and also serves to divide the respective mounting bracket 1111, 1113 into two sections, one for each of the two panels which it is to receive.

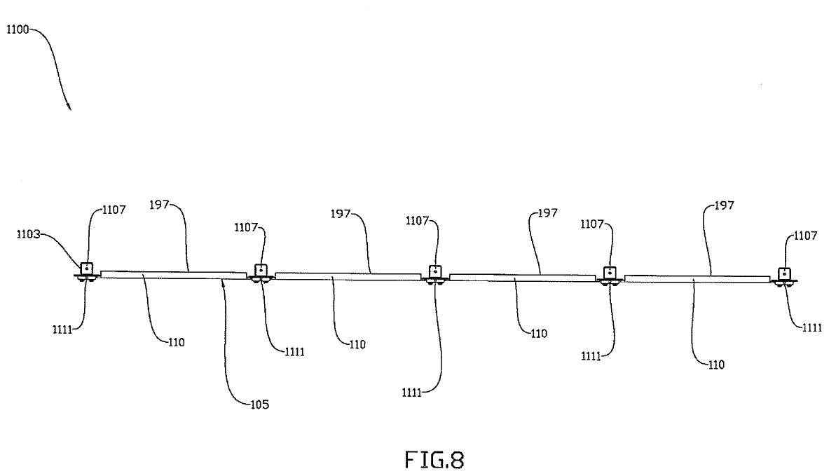

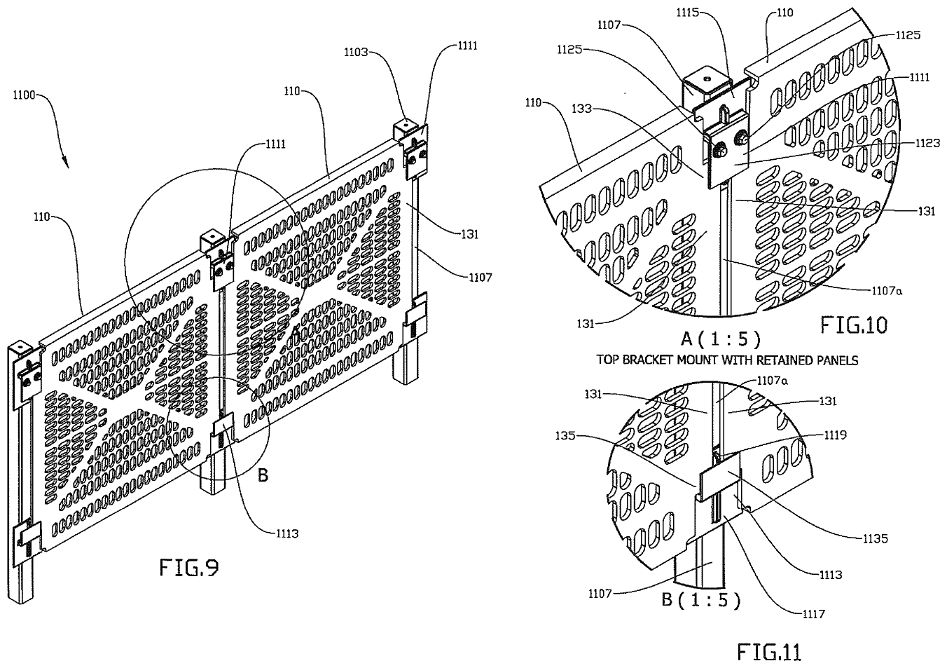

When each panel 110 is mounted on the support structure 1103, the protrusions 131 at the sides of the panel each confront the adjacent face 1107a of the respective post 1107, as best seen in FIGS. 10 and 11. In this way, the post 1107 can assist in reinforcing the panel, functioning as an abutment to limit inward deflection of the side edges 127 of the panel.

The panels 110 are installed in position in the manner illustrated in FIG. 13, with the top edge section 123 of each panel being positioned such that the upper mounting portions 133 are aligned with the open bottom of recesses 1121 of the top mounting brackets 1111. The panel is then lifted upwardly to insert the upper mounting portions 133 into the top mounting brackets 1111. The upward lifting of the panel 110 allows the bottom edge section 125 of the panel to be swung inwardly, with the bottom mounting portions 135 clearing the bottom mounting brackets 1113 and aligning with the open tops of the recesses 1131. The panel 110 can then be lowered such that the lower mounting portion 135 are received in the recesses 1131 and rest on the bases 1133. The panel 110 can then be secured by the locking devices 1125 operable to secure the upper mounting portions 133 of the panel in position.

During installation of each panel 110 in the manner described above, the recesses 129 in the edges of the mounting portions 133, 135 on the panel locate against the protrusions 1119 provided on the mounting bracket 1111, 1113 (as best seen in FIGS. 11 and 12). In this way, the protrusions 1119 function as locators to ensure that the panels 110 are positioned correctly with respect to the mounting bracket 1111, 1113 before being locked in place.

It is notable that the protrusions 131 at the sides of the panel 110 abut the top and bottom plates 1115, 1117 on the respective posts 1107, such that the backing plates provide some lateral support or reinforcement to the panel at the side edge sections 127.

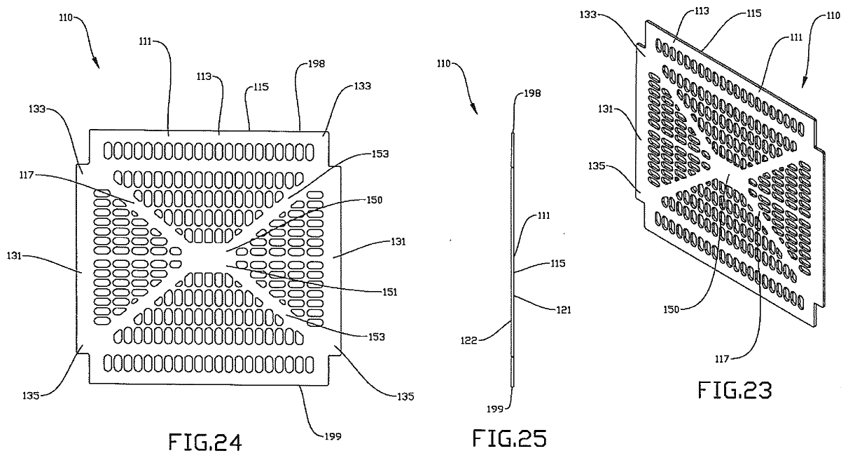

Referring now to FIGS. 23 to 25, there is shown a second embodiment of a panel according to the invention. The panel of the second embodiment is similar in many respects to the panel of the first embodiment and so similar reference numerals are used to identify similar parts. In the second embodiment, the panel is without reinforcement means such as side flanges.

In another embodiment (not shown), the panel is similar in many respects to the panel of the first embodiment, except that, the flanges 197 may be disposed angularly (rather than normally) to one of the faces 121, 122 of the panel 110.

In yet another embodiment (also not shown), the flanges 197 may extend in opposed directions; that is, one may extend from face 121 and the other from face 122.

In yet another embodiment (also not shown), there may be one flange 197 only (which may be either be disposed normally or angularly to either the first face 121 or the second face 122 of the panel 110).

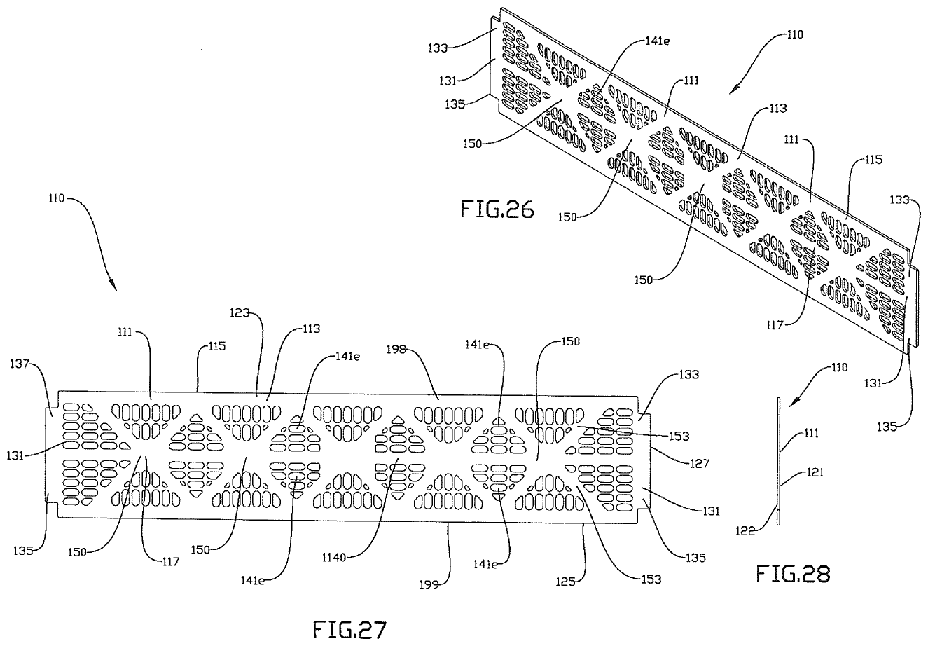

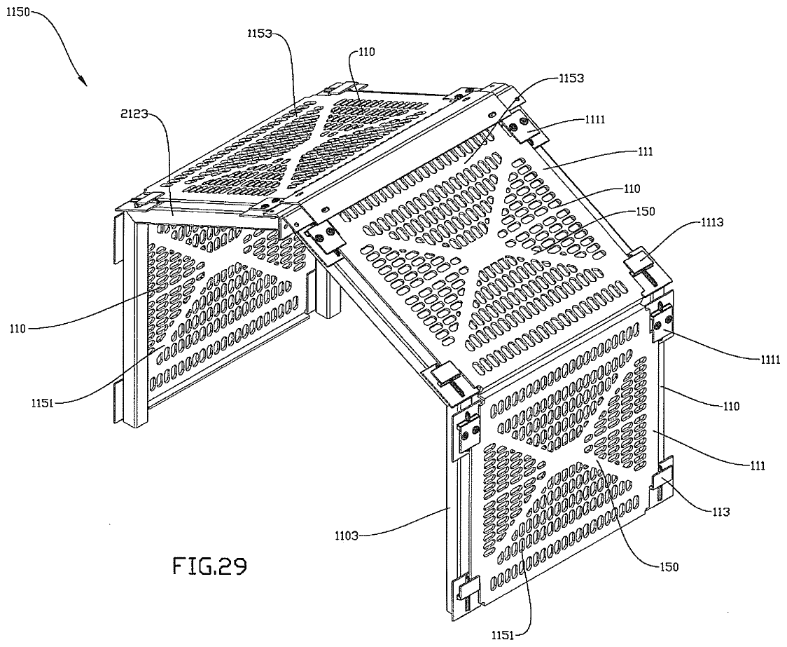

Referring now to FIGS. 26 to 28, there is shown a third embodiment of a panel according to the invention. The panel of this embodiment is similar in certain respects to the panel of the first embodiment and so similar reference numerals are used to identify similar parts. In this embodiment, the panel 110 is configured as rectangle with the top and bottom edge sections 123, 125 being considerably longer than the two opposed side edge sections 127. The body 111 has a plurality of integrated stiffening formations 150 at spaced intervals along its length. The stiffening formations 150 are defined by clusters 141 of openings 140, as is the case in the first embodiment. However, the pattern of the openings 140 is somewhat different, as adjacent stiffening formations 150 share common clusters 141e which are configured accordingly. Further, the individual clusters 141 may be configured to define a central longitudinal web 1140 linking the various stiffening formations 150. The central longitudinal web 1140 may enhance the rigidity of the panel 110.

Referring now to FIG. 29, there is shown an example of a guard 1150 which is suitable for use as conveyor guarding and which uses panels 110 which may be according to any one of the embodiments described. The guard 1150 is fully enclosed in the sense that it has side sections 1151 and a pitched top sections 1153 which cooperate to surround exposed areas of a belt conveyor (not shown). The guard 1150 comprises support structure 1103 on which the panels 110 are mounted to provide the side sections 1151 and the top sections 1153. The guard can, of course be of any suitable configuration, as would be understood by a person skilled in the art.

In the embodiments described and illustrated, the panels 110 are mounted on the support structure 1103 by way of upper and lower attachment brackets 1111, 1113. Further, the locking devices 1125 are associated with the attachment brackets 1111. Other mounting arrangements are contemplated, as well as are other locking arrangements. The panels 110 may, for example, be mounted on a support structure by way of fasteners or other attachment devices. For instance, each panel may be fastened (for example by lugs, studs and/bolted fasteners) to a support frame to provide a fixed machine guard.

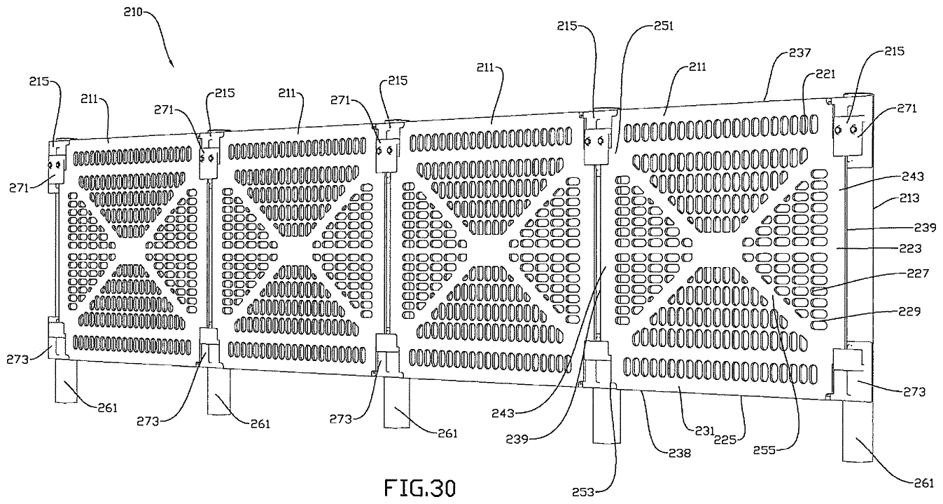

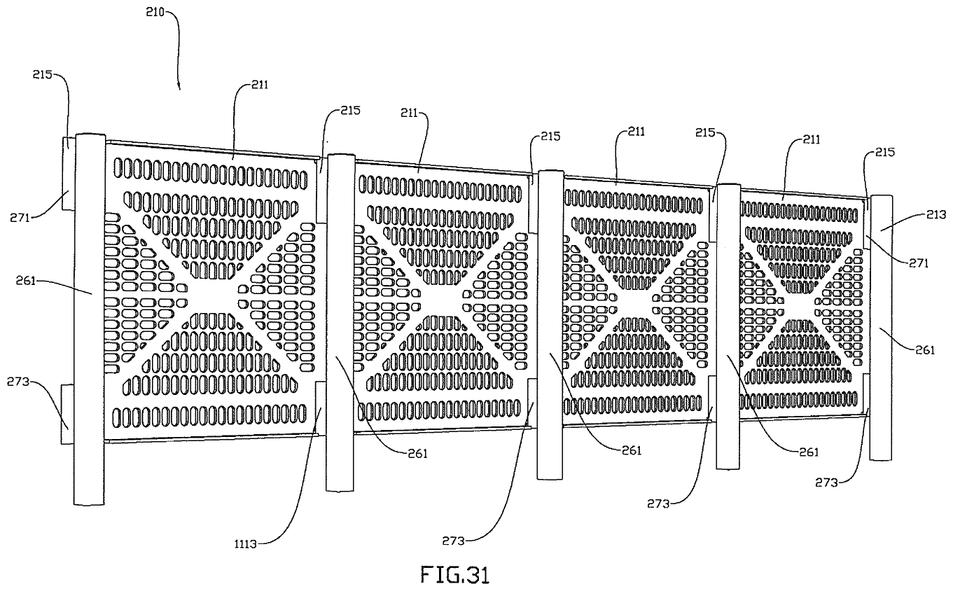

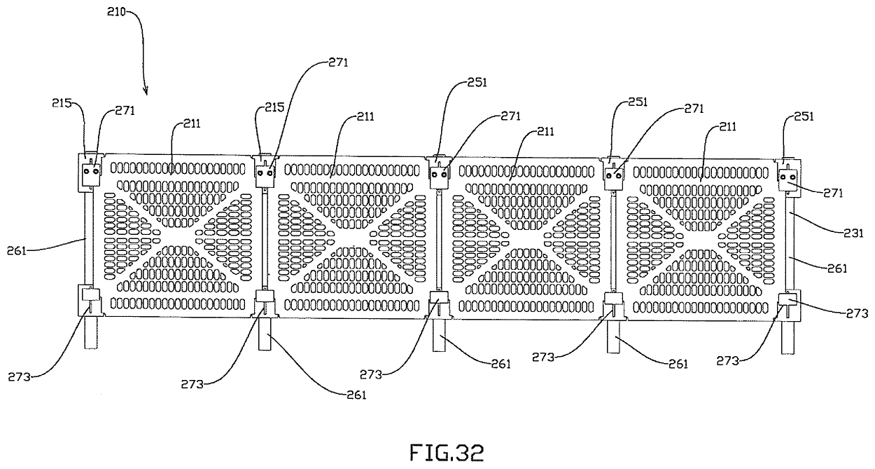

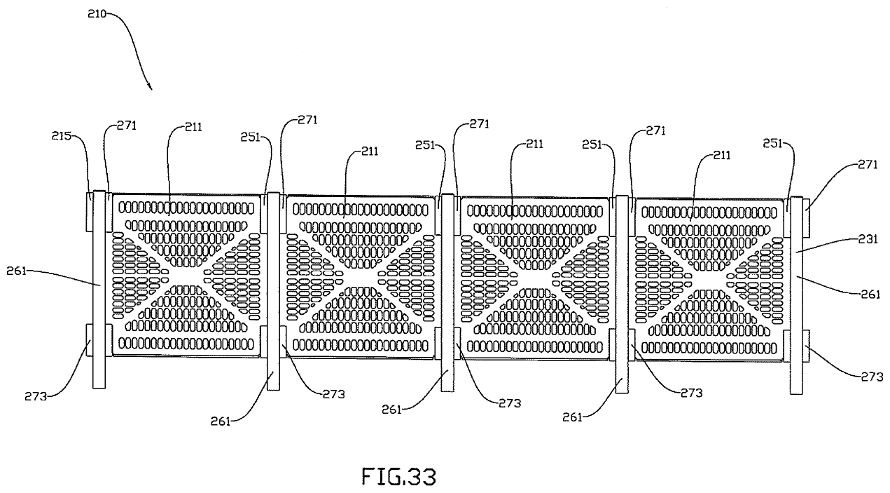

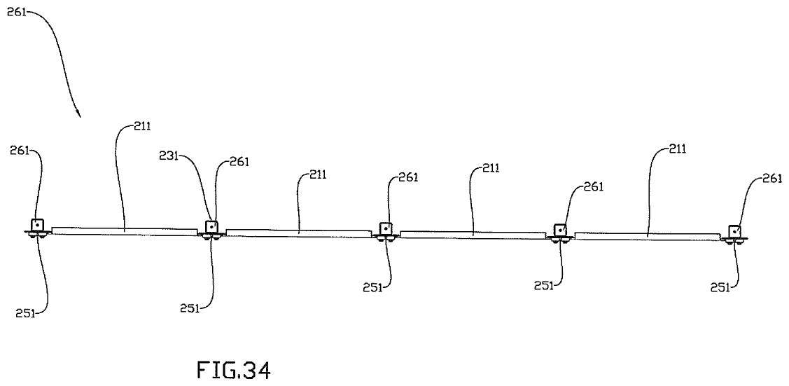

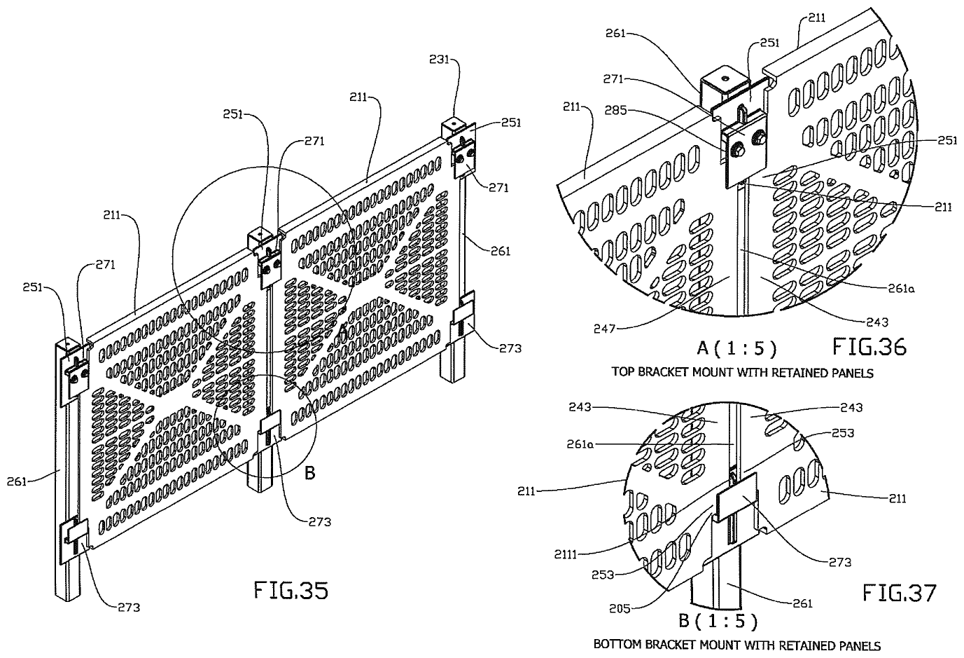

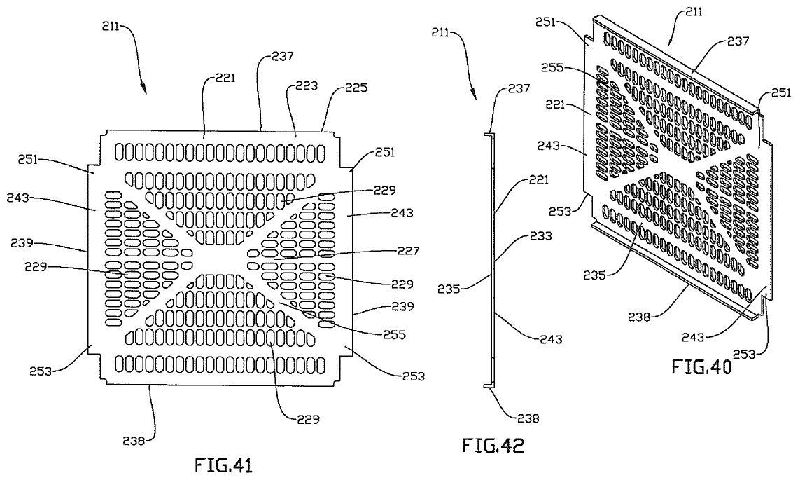

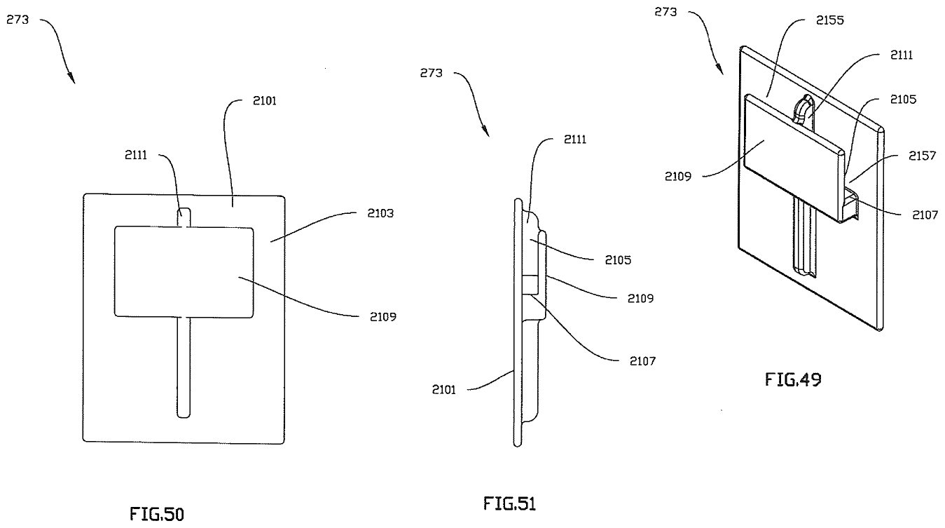

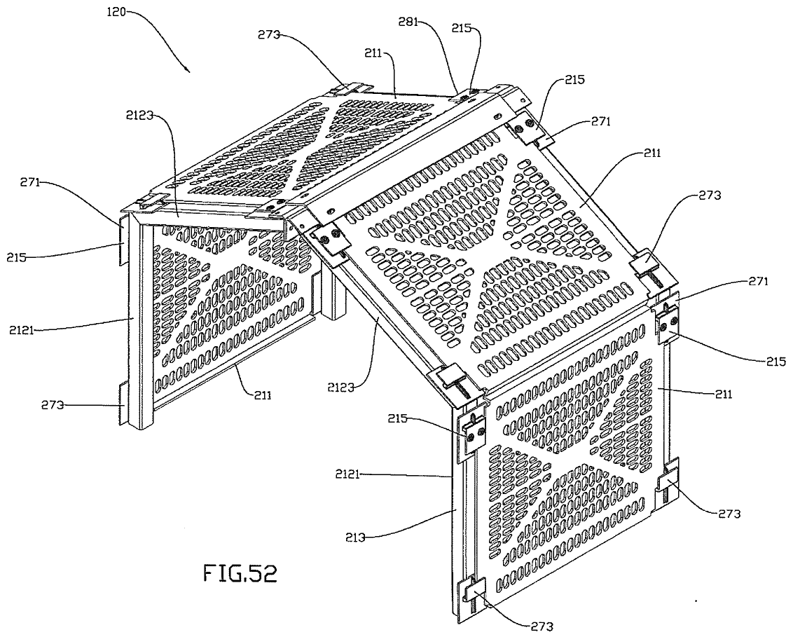

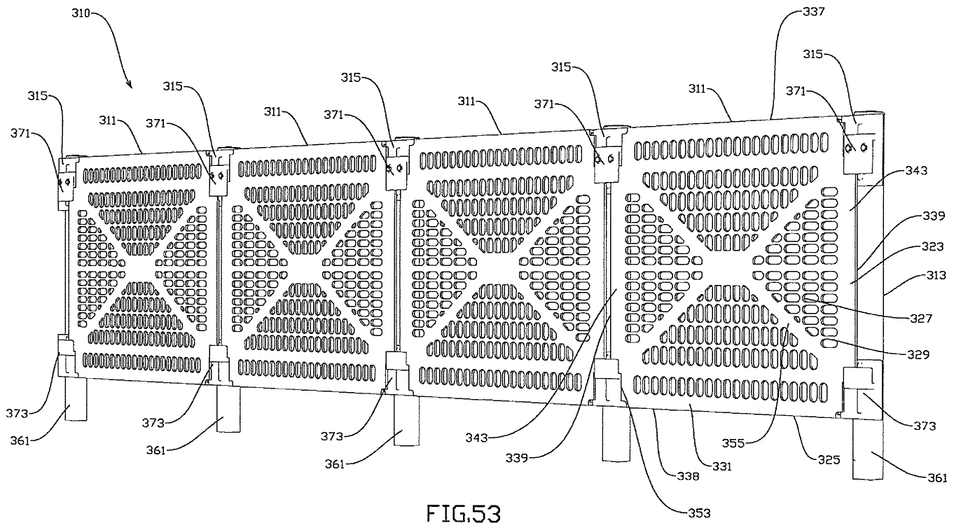

FIGS. 30 to 52 show a barrier according to a fourth and fifth embodiment of the invention.

Referring to FIGS. 30 to 51, there is shown the fourth embodiment of a barrier 210 according to the invention. The barrier 210 is intended for use in in relation to conveyor guarding and other applications where a mesh or perforated panel may be required as safety barrier. However, other applications of the barrier are contemplated, including for example in relation to a machine guard, visual barrier, a fencing panel or a divider.

The barrier 210 comprises an assembly of panels 211 mounted on a support structure 213 by mounting assemblies 215.

In this embodiment, the panels 211 comprise mesh or perforated panels formed rigid non-metal material. The panel 210 may be formed of an engineering plastics material, such as a thermoplastic polymer. A suitable thermoplastic polymer may comprise HPDE, UPE, UHMWPE, PP, PVC and other various plastics, both normal and UV stable. Other rigid non-metal materials are also contemplated, including composite materials.

Each panel 211 is of unitary construction and comprises a body 221 having a marginal portion 223 bounded by a peripheral edge 225. The body 221 has an inner portion 227 in which there are openings 229 to provide the mesh or perforated configuration to the panel 211.

In the arrangement shown, the body 221 is configured as a generally rectangular sheet 231 having first and second opposed faces 233, 235 between which the openings 229 extend. Because of the rectangular configuration of the body 221, the peripheral edge 225 is also generally rectangular and comprises a top edge section 237, a bottom edge section 238 and two opposed side edge sections 239. Each of the side edge sections 239 includes a protrusion 243 providing an upper mounting portion 251 and a lower mounting portion 253 on the respective side of the panel 211, the purpose of which will be explained later. With this arrangement, the upper and lower mounting portions 251, 253 are integrated with the body 221.

In this embodiment, the body 221 is configured to incorporate a stiffening formation 255 (which is integrated with the body) to provide the panel 211 with sufficient lateral stiffness to perform the function of a barrier panel.

In the arrangement shown, the support structure 213 comprises a plurality of support members such as posts 261 installed at intervals, whereby each panel 211 can be mounted between and supported by adjacent posts.

The mounting assemblies 215 each comprises a top mounting bracket 271 and a bottom mounting bracket 273 mounted on each post 261. The top and bottom mounting brackets 271, 273 are each configured to receive two panels 211 which are disposed one adjacent another within the barrier 210 (apart from the top and bottom mounting brackets for end posts (not shown) to which only one panel would be attached). Each mounting bracket 271 and 273 comprises recesses 285 having end openings 2155 and side openings 2157.

The top mounting bracket 271 comprises a top backing plate 281 which presents a face 283 against which the upper mounting portion 251 on the respective side of the panel 211 can locate.

The top mounting bracket 271 is configured to provide a downwardly-opening recess 285 adjacent the top backing plate 281 into which the upper mounting portion 251 on the respective side of the panel 211 can be received and retained. The recess 285 is defined between the top backing plate 281 and an outer portion 287.

The top mounting bracket 271 incorporates two locking devices 289, one for each two panels 211 which can be received in the mounting bracket.

The locking devices 289 may be of any appropriate form, and they need not necessarily be associated with the top mounting bracket 271. The locking devices 289 may, for example, be associated with the bottom mounting bracket 273 or alternatively located separately of the mounting brackets 271, 273.

In the arrangement shown, each locking device 289 comprises a threaded stud 291 having a head 293 adapted to be engaged by a tool (not shown) adapted to rotate the threaded stud to cause it to selectively move into and out of clamping engagement with the upper mounting portion 251 of the respective panel 211 within the downwardly-opening recess 285

The bottom mounting bracket 273 comprises a bottom backing plate 2101 which presents a face 2103 against which the lower mounting portion 253 on the respective side of the panel 211 can locate.

The bottom mounting bracket 273 is configured to provide an upwardly-opening recess 2105 adjacent the bottom backing plate 2101 into which the lower mounting portion 253 on the respective side of the panel 211 can be received and retained. The upwardly-opening recess 2105 has a base 2107 on which the lower mounting portion 253 can rest when received and retained therein. The upwardly-opening recess 2105 is defined between the bottom backing plate 2101 and an outer portion 2109.

A protrusion 2111 which in the arrangement shown is in the form of a rib, is provided on each mounting bracket 271, 273. The rib 2111 functions as a locator (as will be explained below), and also serves to divide the respective mounting bracket 271, 273 into two sections, one for each of the two panels 211 which it is to receive.

When each panel 211 is mounted on the support structure 213, the upper mounting portions 251 of the panel abut the respective top backing plates 281 and the lower mounting portions 253 abut the respective bottom backing plates 2101, whereby lateral forces imposed upon the panel (e.g. when upon sustaining an impact) can be transferred through the mounting brackets 271, 273 to the support structure 213. In other words, the protrusions 243 at the sides of each panel 211 abut the top and bottom backing plates 281, 2101 on the respective mounting brackets 271, 273, such that the backing plates provide some lateral support or reinforcement to the panel at the side edge sections 239.

When each panel 211 is mounted on the support structure 213, the protrusions 243 at the sides of the panel each confront the adjacent face 261a of the respective post 261, as best seen in FIGS. 36 and 37. With this arrangement, two panels 211 mounted on a respective post 261 have adjacent protrusions 243 disposed in front of the adjacent face 261a. In this way, the post 261 can assist in reinforcing the panel 211, functioning as an abutment to limit inward deflection of the side edges 239 of the panel.

The panels 211 are installed in position in the manner illustrated in FIG. 39, with the top edge section 237 of each panel being positioned such that the upper mounting portions 251 are aligned with the open bottom of downwardly-opening recesses 285 of the top mounting brackets 271. The panel 211 is then lifted upwardly to insert the upper mounting portions 251 into the top mounting brackets 271. The upward lifting of the panel 211 allows the bottom edge section 238 of the panel to be swung inwardly, with the lower mounting portions 253 clearing the bottom mounting brackets 273 and aligning with the open tops of the upwardly-opening recesses 2105. The panel 211 can then be lowered such that the lower mounting portions 253 are received in the recesses 2105 and rest on the bases 2107. The panel 211 can then be secured by the locking devices 289 operable to secure the upper mounting portions 251 of the panel in position.

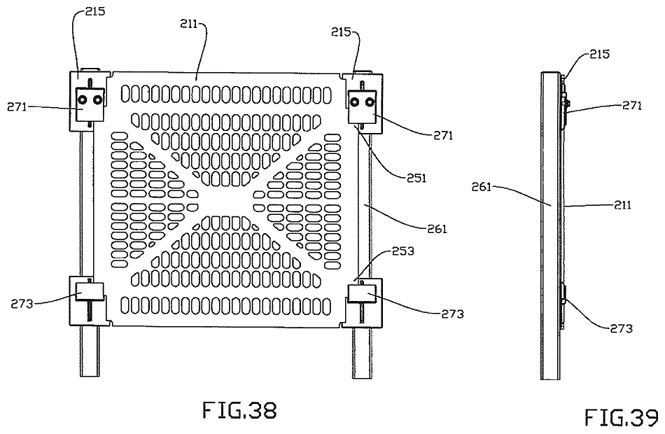

During installation of each panel 211 in the manner described above, the side edges of the mounting portions 251, 253 on the panel locate against the ribs 2111 provided on the mounting bracket 271, 273 (as best seen in FIG. 38). In this way, the ribs 2111 function as locators to ensure that the panels 211 are positioned correctly with respect to the mounting bracket 271, 273 before being locked in place.

Referring now to FIG. 52, there is shown a fifth embodiment of a barrier according to the invention. The barrier of the fifth embodiment is similar in many respects to the barrier of the fourth embodiment and so similar reference numerals are used to identify similar parts.

The barrier of the fifth embodiment is intended for use in in relation to a conveyor barrier guard 2120 which is fully enclosed in the sense that it has side sections 2121 and a pitched top sections 2123 which cooperate to surround exposed areas of a belt conveyor (not shown). The guard 2120 comprises an assembly of panels 211 mounted on a support structure 213 by mounting assemblies 215. In this embodiment, the support structure 213 is configured to provide the side sections 2121 and the top sections 2123. The guard 2120 can, of course, be of any suitable configuration, as would be understood by a person skilled in the art.

From the foregoing, it is evident that each embodiment provides an effective way of mounting a barrier panel in position to provide a barrier. The manner of mounting may assist in providing lateral support to the barrier panel, which may be advantageous in enhancing the lateral stiffness and rigidity of a non-metal barrier panel.

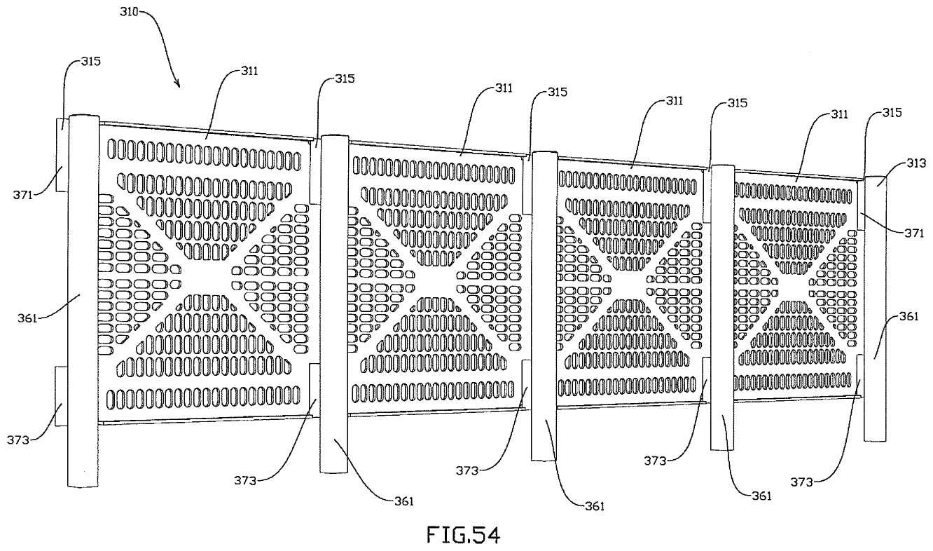

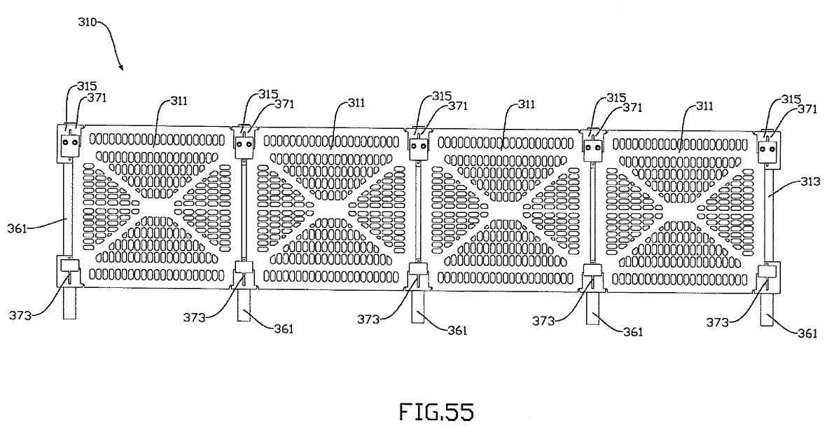

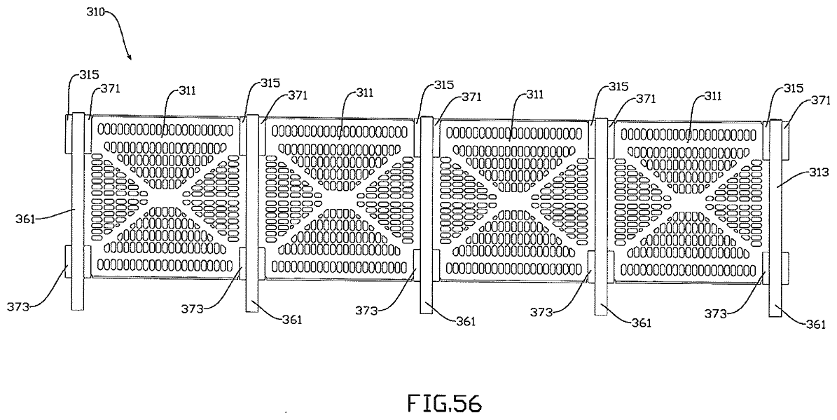

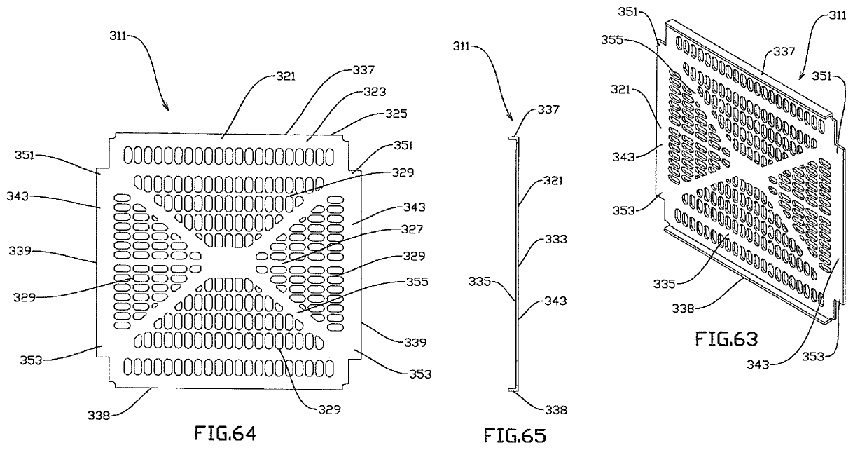

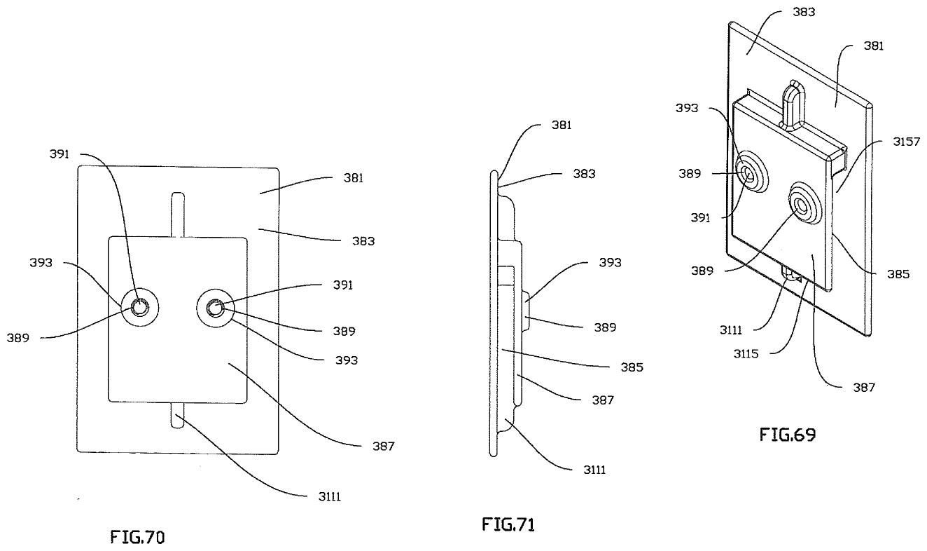

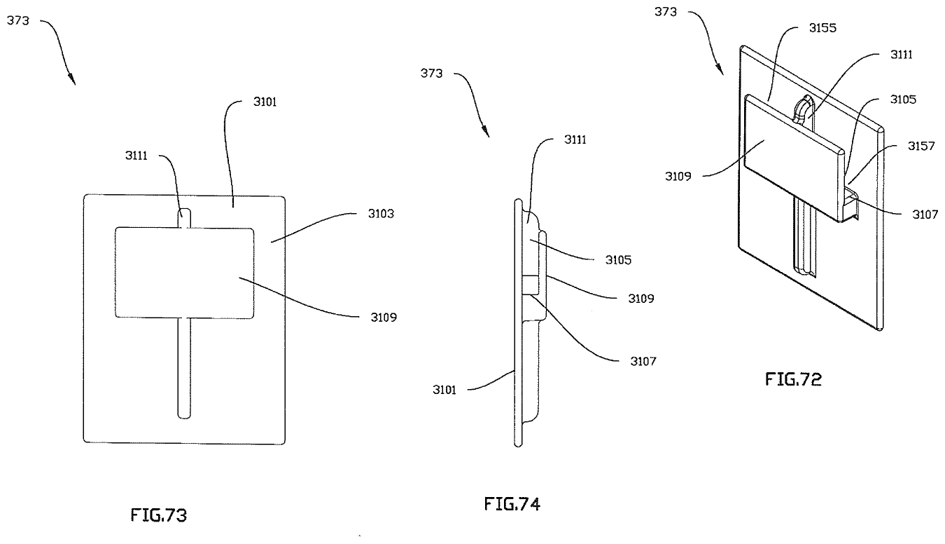

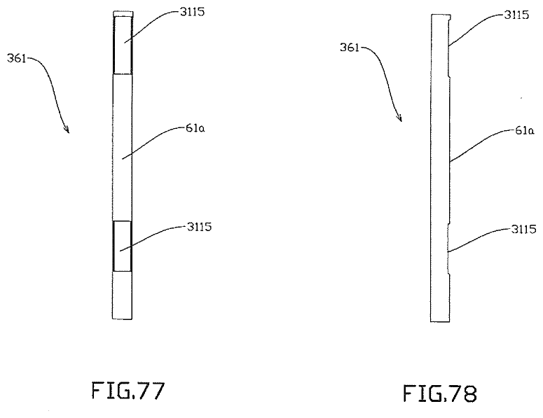

FIGS. 53 to 79 show barrier according to a third and fourth embodiment of the invention.

Referring to FIGS. 53 to 74, there is shown a sixth embodiment of a barrier 310 according to the invention. The barrier 310 is intended for use in in relation to conveyor guarding and other applications where a mesh or perforated panel may be required as safety barrier. However, other applications of the barrier are contemplated, including for example in relation to a machine guard, visual barrier, a fencing panel or a divider.

The barrier 310 comprises an assembly of panels 311 mounted on a support structure 313 by mounting assemblies 315.

In this embodiment, the panels 311 comprise mesh or perforated panels formed rigid non-metal material. The panel 310 may be formed of an engineering plastics material, such as a thermoplastic polymer. A suitable thermoplastic polymer may comprise HPDE, UPE, UHMWPE, PP, PVC and other various plastics, both normal and UV stable. Other rigid non-metal materials are also contemplated, including composite materials.

Each panel 311 is of unitary construction and comprises a body 321 having a marginal portion 323 bounded by a peripheral edge 325. The body 321 has an inner portion 327 in which there are openings 29 to provide the mesh or perforated configuration to the panel 311.

In the arrangement shown, the body 321 is configured as a generally rectangular sheet 331 having first and second opposed faces 333, 335 between which the openings 329 extend. Because of the rectangular configuration of the body 321, the peripheral edge 325 is also generally rectangular and comprises a top edge section 337, a bottom edge section 338 and two opposed side edge sections 339. Each of the side edge sections 339 includes a protrusion 343 providing an upper mounting portion 351 and a lower mounting portion 353 on the respective side of the panel 311, the purpose of which will be explained later. With this arrangement, the upper and lower mounting portions 351, 353 are integrated with the body 321.

In this embodiment, the body 321 is configured to incorporate a stiffening formation 355 (which is integrated with the body) to provide the panel 311 with sufficient lateral stiffness to perform the function of a barrier panel.

In the arrangement shown, the support structure 313 comprises a plurality of support members such as posts 361 installed at intervals, whereby each panel 311 can be mounted between and supported by adjacent posts.

The mounting assemblies 315 each comprises a top mounting bracket 371 and a bottom mounting bracket 373 mounted on each post 361. The top and bottom mounting brackets 371, 373 are each configured to receive two panels 311 which are disposed one adjacent another within the barrier 310 (apart from the top and bottom mounting brackets for end posts (not shown) to which only one panel would be attached). Each mounting bracket 371,373 comprises recesses 385 having end openings 3155 and side openings 3157.

The top mounting bracket 371 comprises a top backing plate 381 which presents a face 383 against which the upper mounting portion 351 on the respective side of the panel 311 can locate.

The top mounting bracket 371 is configured to provide a downwardly-opening recess 385 adjacent the top backing plate 381 into which the upper mounting portion 351 on the respective side of the panel 311 can be received and retained. The recess 385 is defined between the top backing plate 381 and an outer portion 387.

The top mounting bracket 371 incorporates two locking devices 389, one for each two panels 311 which can be received in the mounting bracket.

The locking devices 389 may be of any appropriate form, and they need not necessarily be associated with the top mounting bracket 371. The locking devices 389 may, for example, be associated with the bottom mounting bracket 373 or alternatively located separately of the mounting brackets 371, 373.

In the arrangement shown, each locking device 389 comprises a threaded stud 391 having a head 391 adapted to be engaged by a tool (not shown) adapted to rotate the threaded stud to cause it to selectively move into and out of clamping engagement with the upper mounting portion 351 of the respective panel 311 within the downwardly-opening recess 385

The bottom mounting bracket 373 comprises a bottom backing plate 3101 which presents a face 3103 against which the lower mounting portion 353 on the respective side of the panel 311 can locate.

The bottom mounting bracket 373 is configured to provide an upwardly-opening recess 3105 adjacent the bottom backing plate 3101 into which the lower mounting portion 353 on the respective side of the panel 311 can be received and retained. The upwardly-opening recess 3105 has a base 3107 on which the lower mounting portion 353 can rest when received and retained therein. The upwardly-opening recess 3105 is defined between the bottom backing plate 3101 and an outer portion 3109.

A protrusion 3111 which in the arrangement shown is in the form of a rib, is provided on each mounting bracket 371, 373. The rib 3111 functions as a locator (as will be explained below), and also serves to divide the respective mounting bracket 371, 373 into two sections, one for each of the two panels 311 which it is to receive.

When each panel 311 is mounted on the support structure 313, the upper mounting portions 351 of the panel abut the respective top backing plates 381 and the lower mounting portions 353 abut the respective bottom backing plates 3101, whereby lateral forces imposed upon the panel (e.g. when upon sustaining an impact) can be transferred through the mounting brackets 371, 373 to the support structure 313. In other words, the protrusions 343 at the sides of each panel 311 abut the top and bottom backing plates 381, 3101 on the respective mounting brackets 371, 373, such that the backing plates provide some lateral support or reinforcement to the panel at the side edge sections 339.

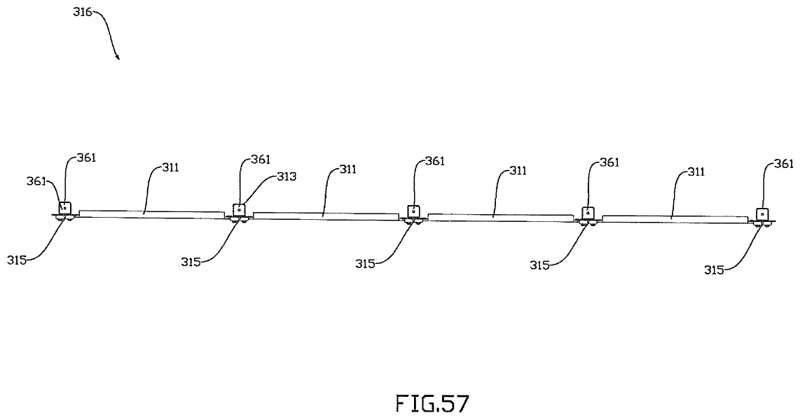

When each panel 311 is mounted on the support structure 313, the protrusions 343 at the sides of the panel each confront the adjacent face 361a of the respective post 361, as best seen in FIGS. 59 and 60. With this arrangement, two panels 311 mounted on a respective post 361 have adjacent protrusions 343 disposed in front of the adjacent face 361a. In this way, the post 361 can assist in reinforcing the panel 311, functioning as an abutment to limit inward deflection of the side edges 339 of the panel.

The panels 311 are installed in position in the manner illustrated in FIG. 62, with the top edge section 337 of each panel being positioned such that the upper mounting portions 351 are aligned with the open bottom of downwardly-opening recesses 385 of the top mounting brackets 371. The panel 311 is then lifted upwardly to insert the upper mounting portions 351 into the top mounting brackets 371. The upward lifting of the panel 311 allows the bottom edge section 338 of the panel to be swung inwardly, with the lower mounting portions 353 clearing the bottom mounting brackets 373 and aligning with the open tops of the upwardly-opening recesses 3105. The panel 311 can then be lowered such that the lower mounting portions 353 are received in the recesses 3105 and rest on the bases 3107. The panel 311 can then be secured by the locking devices 389 operable to secure the upper mounting portions 351 of the panel in position.

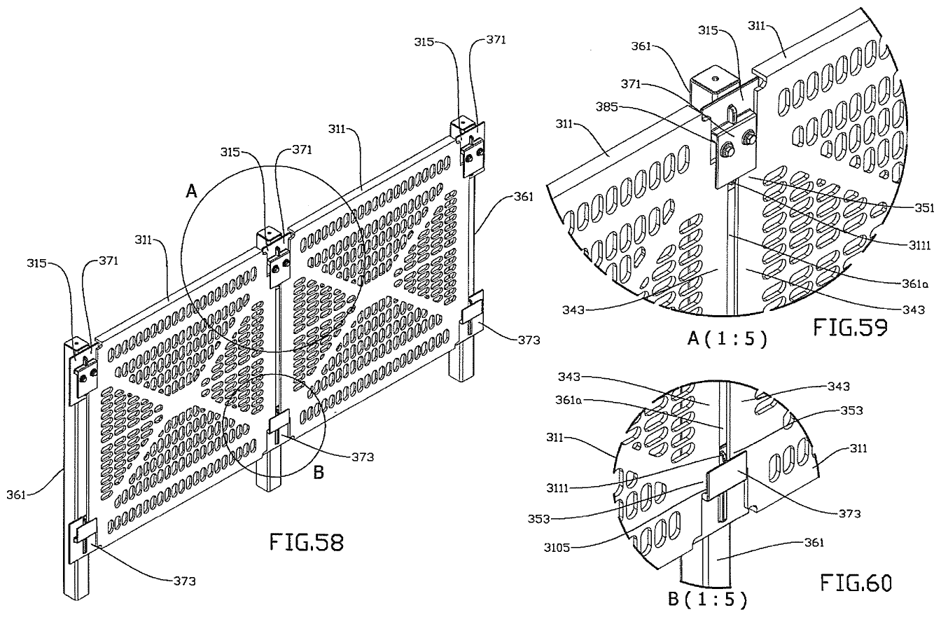

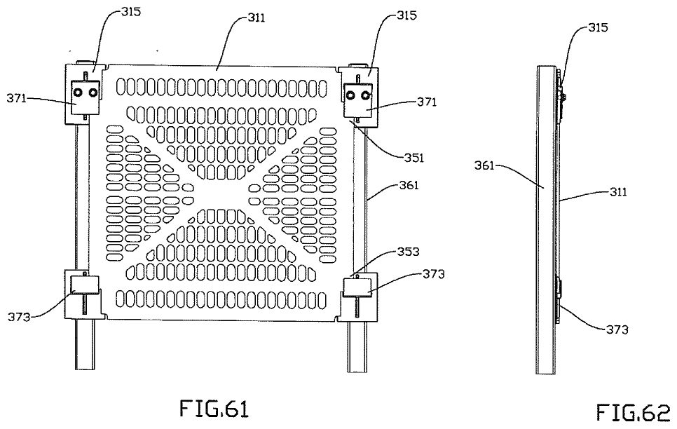

During installation of each panel 311 in the manner described above, the side edges of the mounting portions 351, 353 on the panel locate against the ribs 3111 provided on the mounting bracket 371, 373 (as best seen in FIG. 61). In this way, the ribs 3111 function as locators to ensure that the panels 311 are positioned correctly with respect to the mounting bracket 371, 373 before being locked in place.

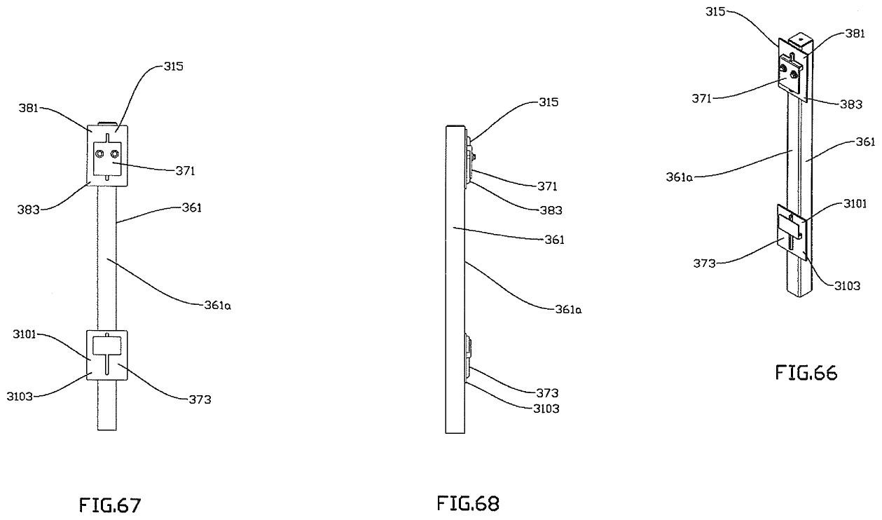

In the sixth embodiment, each post 361 supports a respective top mounting bracket 371 and a respective bottom mounting bracket 373. As described above, the top mounting bracket 371 comprises top backing plate 381 presenting face 383, and the bottom mounting bracket 373 comprises bottom backing plate 3101 presenting face 3103. In the arrangement shown, the top mounting bracket 371 and the bottom mounting bracket 373 are each mounted on face 361a of the post 361. With such an arrangement, the faces 383, 3103 are offset outwardly of the face 361a of the post 361, as best seen in FIGS. 66 and 68; that is, the faces 383, 3103 are proud of face 361a of the post 361. When a respective panel 311 is mounted in position on the post 361, the protrusion 343 at the respective side of the panel 311 abuts the faces 383, 3103 on the respective mounting brackets 371, 373 such that the backing plates 381, 3101 provide some lateral support or reinforcement to the panel at the side edge section 339. However, the protrusion 343 at the respective side of the panel 311 does not abut face 361a of the post 361 (because the faces 383, 3103 on the respective mounting brackets 371, 373 are offset outwardly of the face 361a of the post 361).

It may be advantageous for the protrusion 343 at the respective side of the panel to abut not only the faces 383, 3103 on the respective mounting brackets 371, 373, but also the face 361a of the post 361 so as to be better supported, thereby affording enhanced resistance to inward deflection of the side edge 339 of the panel.

Such an arrangement is a feature of a seventh embodiment of a barrier according to the invention. The barrier of the seventh embodiment is similar in many respects to the barrier of the first embodiment and so similar reference numerals are used to identify similar parts.

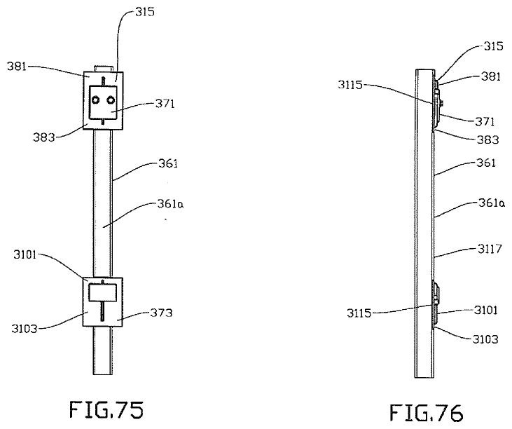

In this seventh embodiment, which will be described with reference to FIGS. 75 to 78, each support post 361 has two recesses 3115 configured as notches extending inwardly from the face 361a. The recesses 3115 are sized and shaped to receive the mounting brackets 371, 373, with the respective backing plates 381, 3101 being accommodated within the recesses 3115 and the respective faces 383, 3103 being flush with the adjacent face 361a of the post, as best seen in FIG. 76.

With such an arrangement, the face 361a of the post 361 and the respective faces 383, 3103 of the backing plates 381, 3101 cooperate to define an extended surface 3117 against which the entirety of the protrusion 343 at the respective side of the panel 311 can locate, including upper and lower mounting portions 351, 353. This offers more support for the protrusion 343, and the side edge 339 overall, against inward deflection of the panel 311.

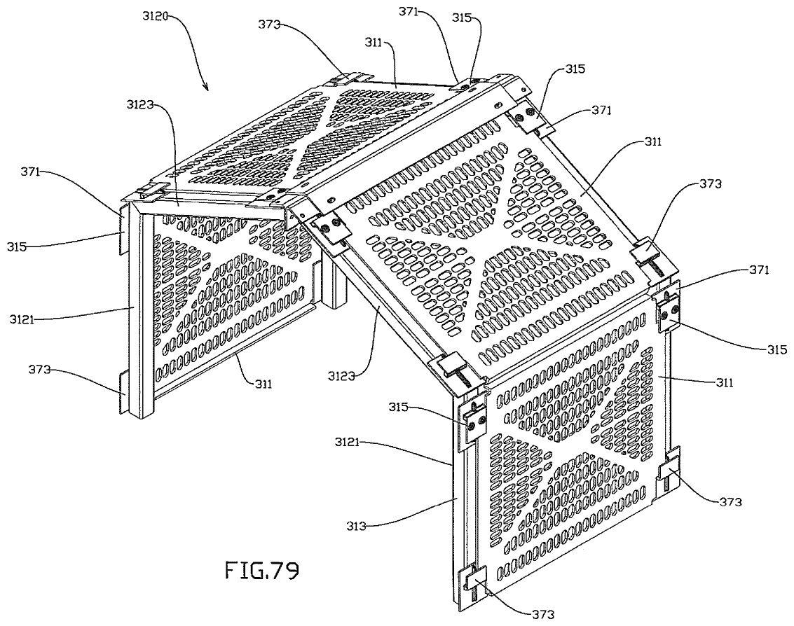

Referring now to FIG. 79, there is shown an eighth embodiment of a barrier according to the invention. The barrier of the third embodiment is similar in many respects to the barrier of the first embodiment and so similar reference numerals are used to identify similar parts.

The barrier of the eight embodiment is intended for use in in relation to a conveyor barrier guard 3120 which is fully enclosed in the sense that it has side sections 3121 and a pitched top sections 3123 which cooperate to surround exposed areas of a belt conveyor (not shown). The guard 3120 comprises an assembly of panels 311 mounted on a support structure 313 by mounting assemblies 315. In this embodiment, the support structure 313 is configured to provide the side sections 3121 and the top sections 3123. The guard 3120 can, of course, be of any suitable configuration, as would be understood by a person skilled in the art.

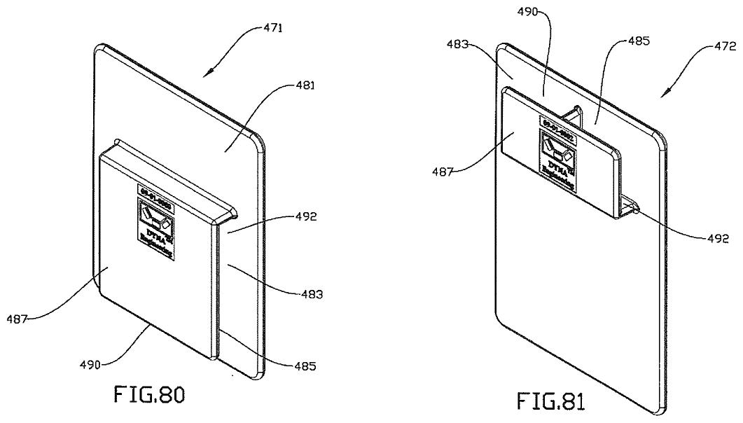

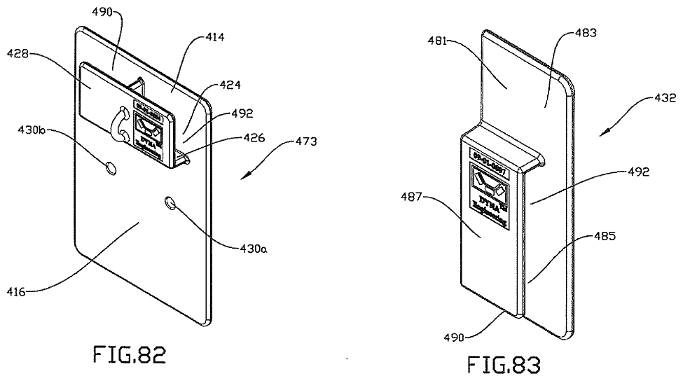

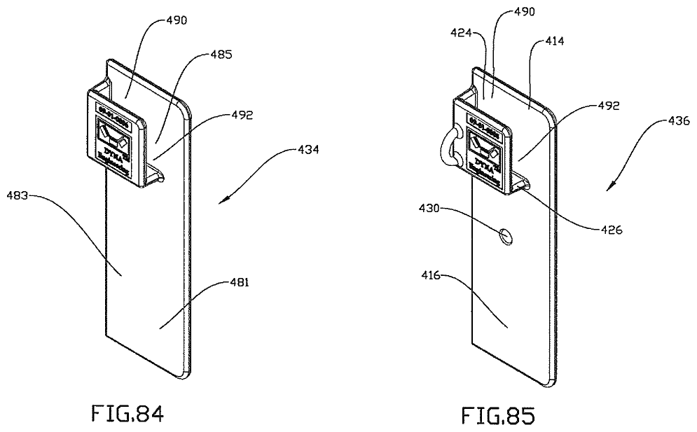

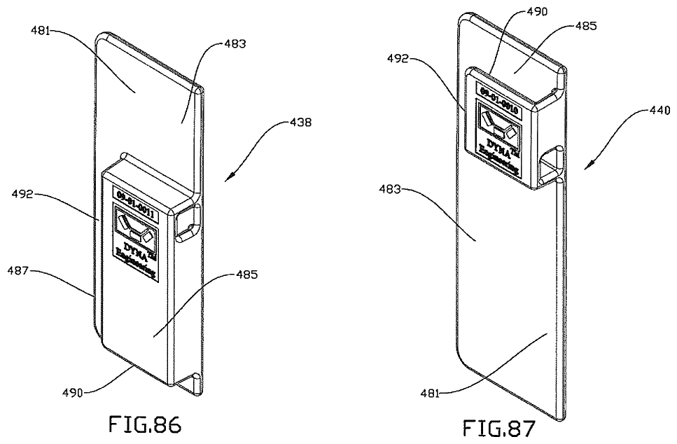

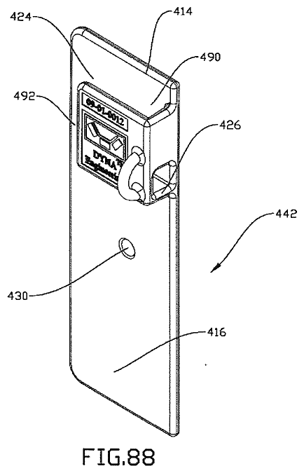

Referring now to FIGS. 80 to 94, these figures show particular arrangement of mounting brackets of mounting assemblies 415 in accordance with present embodiments of the invention.

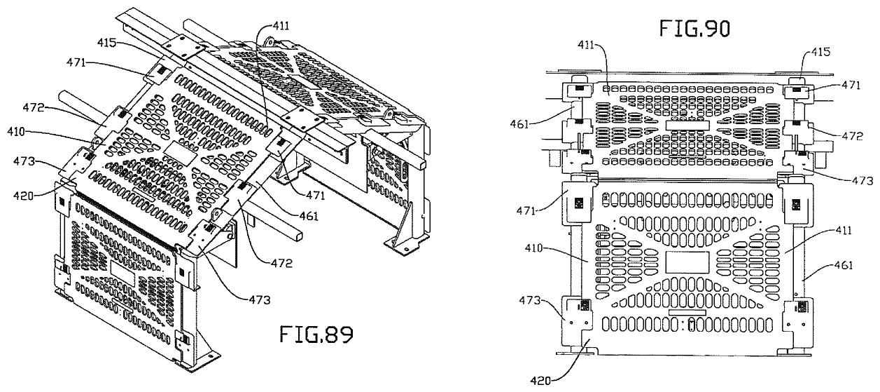

FIGS. 89 to 91 shows mounting brackets 471 to 473 in use. Panels 411 may be secured to posts 461 using mounting assemblies 415 as was described with reference to the previously describe embodiments.

As shown in FIGS. 89 and 90, panels 411 may be secured with mounting assemblies 415 having two or more mounting brackets attached to each post 461.

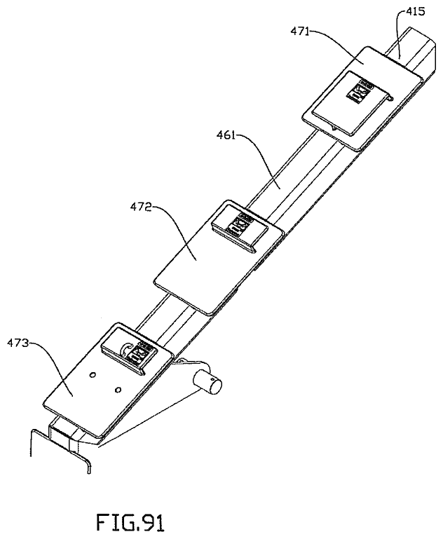

The mounting assemblies 415 each comprises a top mounting bracket 471, a centre mounting bracket 472 and a bottom mounting bracket 473 mounted on each post 461 (see FIG. 91). The top, centre and bottom mounting brackets 471 to 473 are each configured to receive two panels 411 which are disposed one adjacent another within the barrier 210 (apart from the left and right hand mounting brackets 432 to 442 (shown in FIGS. 83 to 88) for end posts (not shown) to which only one panel would be attached).

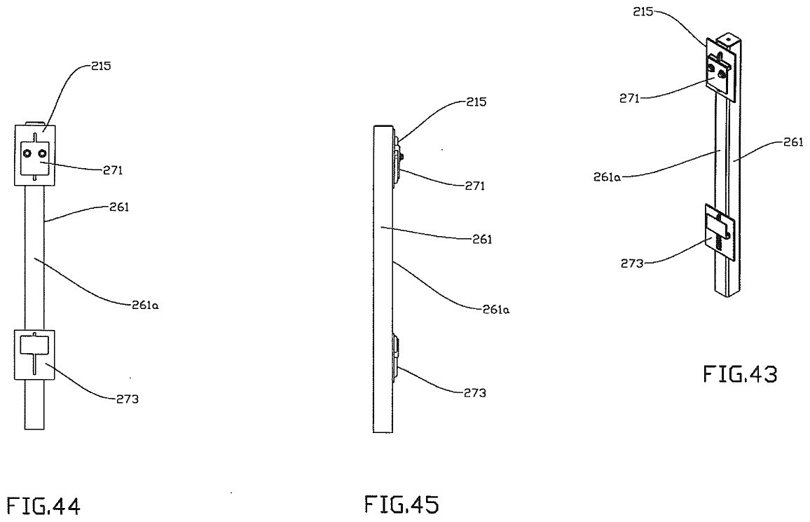

The top mounting bracket 471 is shown in FIG. 80 and is similar to the top mounting brackets 271 shown in FIGS. 43 and 46 to 48. The top mounting bracket 471 comprises a top backing plate 481 which presents a face 483 against which the upper mounting portion on the respective side of the panel 411 can be located.

The top mounting bracket 471 is configured to provide a downwardly-opening recess 485 adjacent the top backing plate 481 into which the upper mounting portion on the respective side of the panel 411 can be received and retained. The recess 485 is defined between the top backing plate 481 and an outer portion 487.

The centre mounting bracket 472 is shown in FIG. 81 and comprises a top backing plate 481 which presents a face 483 against which a portion on the respective side of the panel 411 can be located.

The centre mounting bracket 472 is configured to provide an upwardly-opening recess 485 adjacent the top backing plate 481 into which a portion on the respective side of the panel 411 can be received and retained as seen in FIG. 89. The recess 485 is defined between the top backing plate 481 and an outer portion 487.

Further, the face 483 is adapted to receive an upper portion of tab 410 of panel 411 defined by a first cut-out machined in the sides of the panel 411.

The bottom mounting bracket 473 comprises a bottom backing plate 414 which presents a face 416 against which portions on the respective side of the panel 411 can be located. In particular, as shown in FIG. 89, a lower portion of the tab 410 and the tab 420 defined by a second cut-out machined in the sides of the panel 411.

The bottom mounting bracket 473 is configured to provide an upwardly-opening recess 424 adjacent the bottom backing plate 414 into which the lower mounting portion on the respective side of the panel 411 can be received and retained. The upwardly-opening recess 424 has a base 426 on which the lower mounting portion can rest when received and retained therein. The upwardly-opening recess 424 is defined between the bottom backing plate 414 and an outer portion 428.

Further, the bottom mounting bracket 473 comprises screwed openings 430a and 30b for receiving screws.

Each mounting bracket 471 to 473 and 432 to 442 comprises recesses 425 and 485 having end openings 490 and side openings 492.

FIGS. 89 to 91 show a particular arrangement of a mounting assembly 415 with mounting brackets 471 to 473 arranged, respectively, on the upper end, centre, and lower end of the post 461. However, in alternative arrangements, any of the mounting brackets 471 to 473 (as well as 432 to 442, if applicable) may be located either on the top, centre and bottom of the post 461 wherein: (1) the particular mounting brackets 471, 472, or 473 (as well as 432, 434 or 442) that is located on the upper end of the posts 461 will be oriented such that their recess is an upward-opening recess 424 and including the base 426 for receiving the lower mounting portion of the panel 411; and (2) the particular mounting brackets 471, 472, or 473, (as well as 432, 434 or 442, if applicable) that are located on the lower end of the posts 461 will be oriented such that their recess is an downward-opening recess 485.

Referring now to FIGS. 83 to 85 and 86 to 88, these figures show mounting brackets 432 to 436 and 438 to 442. These particular mounting brackets 432 to 442 are similar and have similar components when compared against mounting brackets 471 to 473; thus, similar reference numerals are used to identify similar components.

The difference between mounting brackets 432 to 442 and when compared against brackets 471 to 473 (see FIGS. 80 to 83) is that the mounting brackets 432 to 442 are attached to end posts of the barriers in accordance with the present embodiments of the invention; and thus, are configured for receiving a single side of a panel 411. In particular, mounting brackets 432 to 436 are left-hand mounting brackets for receiving the left side of the panel 411; and mounting assemblies 438 to 442 are right-hand mounting brackets for receiving the right side of the panel 411.

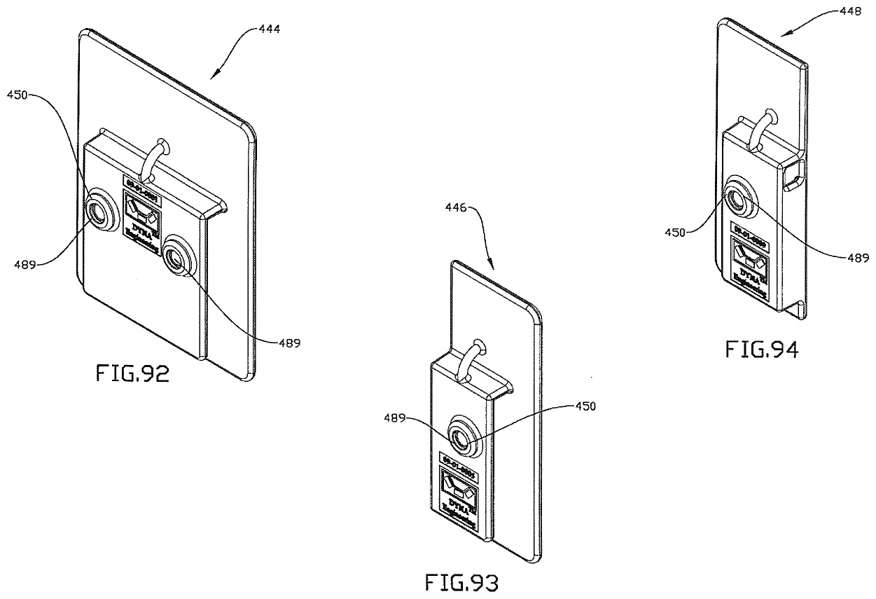

Referring now to FIGS. 92 to 94, these figures show particular arrangement of mounting brackets 444 to 448. Mounting bracket 444 incorporates two locking devices 489, one for each two panels 411 which can be received in the mounting bracket. Mounting bracket 446 and 448 (due to being adapted to receive only one side—either left side or right side—of a panel 411) incorporate a single locking device 489 for securing the panel 411 to be received in the mounting brackets 446 and 448.

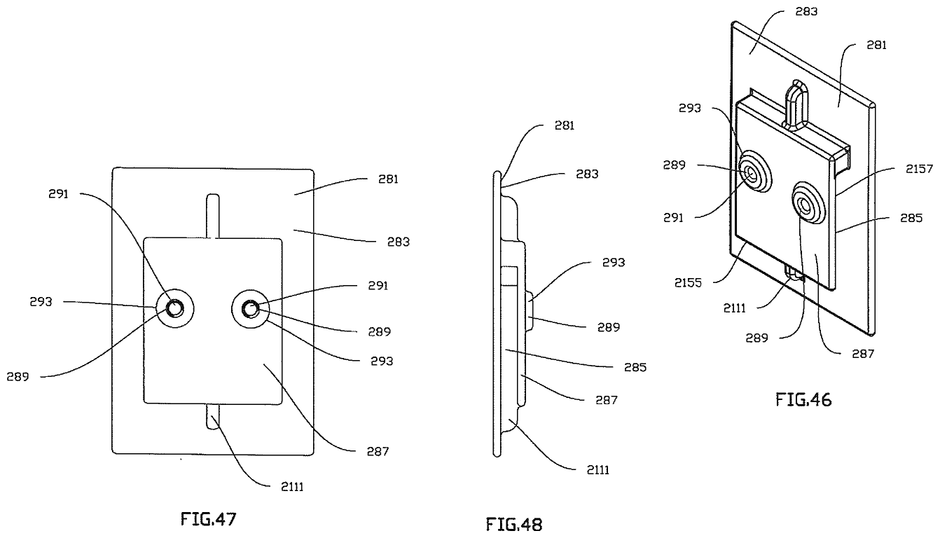

The locking devices 489 comprise welded nut 450 and are substantially identical, for example, to the locking devices 289 described previously in relation to FIGS. 46 to 48.

The foregoing disclosure is intended to explain how to fashion and use the particular embodiments described, rather than to limit the true, intended, and fair scope and spirit of the present disclosure. The foregoing description is not intended to be exhaustive, nor to be limited to the precise forms disclosed.

It should be appreciated that various modifications can be made without departing from the principles described herein. Therefore, the principles should be understood to include all such modifications within its scope.

The method steps, processes, and operations described herein are not to be construed as necessarily requiring their performance in the particular order discussed or illustrated, unless specifically identified as an order of performance. It is also to be understood that additional or alternative steps may be employed.

The terminology used herein is for the purpose of describing particular example embodiments only and is not intended to be limiting.

As used herein, the singular forms “a”, “an” and “the” may be intended to include the plural forms as well, unless the context clearly indicates otherwise.

Reference to any positional descriptions, such as “top”, “bottom” and “side”, are to be taken in context of the embodiments described and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g. “between” versus “directly between,” “adjacent” versus “directly adjacent,” etc.). As used herein, the term “and/or” includes any and all combinations of one or more of the associated listed items.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Throughout this specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

Future patent applications maybe filed in Australia or overseas on the basis of, or claiming priority from, the present application. It is to be understood that the following claims are provided by way of example only, and are not intended to limit the scope of what may be claimed in any such future application. Features may be added to or omitted from the provisional claims at a later date so as to further define or re-define the invention or inventions.

1. A panel comprising:
a body having a marginal portion bounded by a peripheral edge and an inner portion, and
a plurality of openings extending through the inner portion,
wherein the openings are arranged in a pattern to define a stiffening formation devoid of any of the plurality of openings and defining pathways extending from the inner portion of the body to the marginal portion such that stresses arising in the panel are transferred from the inner portion to the marginal portion of the body.

2-4. (canceled)

5. The panel according to claim 1, wherein the stiffening formation defines an inner section and a plurality of webs extending outwardly from the inner section to the marginal portion of the body.

6-8. (canceled)

9. The panel according to claim 5, wherein the plurality of webs may comprise four webs.

10. The panel according to claim 1, wherein the stiffening formation is arranged in a substantial X configuration.

11-12. (canceled)

13. The panel according to claim 1, wherein the pattern defined by the arrangement of the plurality of openings comprises clusters which cooperate to define the stiffening formation.

14. The panel according to claim 13, wherein each defined pathway extends between two adjacent clusters.

15-20. (canceled)

21. The panel according to claim 13, wherein each of the plurality of openings is shaped to define a longitudinal axis and the plurality of openings are oriented such that the longitudinal axes of the openings in each cluster are either aligned with or parallel to one another.

22-38. (canceled)

39. The panel according to claim 1, further comprising at least one side flange that extends along a peripheral edge of the body to reinforce the panel.

40. The panel according to claim 39, further comprising a pair of side flanges that are provided on opposite peripheral edges of the body that define top and bottom portions of the panel when the panel is mounted.

41. (canceled)

42. The panel according to claim 1, further comprising a mount integrated with the body and adapted to mount the panel to a support structure.

43. The panel according to claim 42, wherein the mount is in the form of at least one protrusion extending along a portion of a peripheral edge of the body.

44-49. (canceled)

50. The panel according to claim 43, further comprising protrusions extending along at least a portion of opposite peripheral edges of the body that define side portions of the panel when mounted.

51-77. (canceled)

78. The panel according to claim 21, wherein each cluster is associated with a peripheral edge of the panel, and wherein the openings of a cluster are oriented such that the longitudinal axis of each opening of that cluster are substantially normal to the associated peripheral edge of the cluster.

79. A panel according to claim 1, being formed of rigid non-metal material.

80. A barrier or guard comprising:
at least one panel as defined in claim 1, and
a support structure having at least one mounting bracket for mounting the at least one panel to the support structure.

81. A barrier or guard of claim 80, wherein the support structure comprises a frame portion, and wherein the barrier or guard is configured such that when the at least one panel is mounted to the support structure via the at least one mounting bracket, wherein a portion of the panel rests against the frame portion.

82. A barrier or guard of claim 81, wherein the frame portion is in the form of a support post.

83. A barrier or guard of claim 80, wherein the at least one mounting bracket further comprises a backing plate having a face, and an outer portion spaced apart from the backing plate thereby defining a recess for receiving a peripheral edge or mounting portion of the at least one panel, and wherein the face of the backing plate comprises an unexposed area located below the outer portion, and an exposed area extending beyond the recess for the exposed area to provide support to the panel such that the peripheral edge or mounting portion of the at least one panel rests against the exposed area when mounted onto the support structure.

84. A barrier or guard according to claim 80, wherein the at least one mounting bracket comprises a locking device that is configured such that when the at least one panel is mounted to the support structure, the locking device restricts lateral movement of the at least one panel.

85. A barrier or guard according to claim 80, wherein the support structure comprises a plurality of support posts installed at intervals, whereby a panel is mounted between and supported by adjacent posts.
